(19) United States
(12) Patent Application Publication
(10) Pub. No.: US 2016/0040514 A1
(43) Pub. Date: Feb. 11, 2016

(54) Reservoir Characterization and Hydraulic Fracture Evaluation

(71) Applicant: BOARD OF REGENTS, THE UNIVERSITY OF TEXAS SYSTEM, Austin, TX (US)

(72) Inventors: Amir Reza Rahmani, Austin, TX (US); Mohsen Ahmadian-Tehrani, Austin, TX (US); Alex Edward Athey, Austin, TX (US)

(73) Assignee: BOARD OF REGENTS, THE UNIVERSITY OF TEXAS SYSTEM, Austin, TX (US)

(21) Appl. No.: 14/773,875

(22) PCT Filed: Mar. 14, 2014
(86) PCT No.: PCT/US14/29517

§ 371 Date: Sep. 9, 2015

Related U.S. Application Data
(60) Provisional application No. 61/792,905, filed on Mar. 15, 2013.

(51) Int. Cl. E21B 43/00; G06F 17/10; E21B 47/00

(52) U.S. Cl. CPC E21B 43/00; E21B 47/00; G06F 17/10

(57) ABSTRACT

A multi-physics and multi-scale system and process to simulate imaging of hydrocarbon reservoirs using electromagnetic particles and electromagnetic tomography. Embodiments are applicable towards flood-front mapping and hydraulic fracture imaging. With respect to flood-front mapping, coated nanoparticles (or their software representation) may be injected. In case of fracture imaging, the contrast agents (or their software representation) may either be injected as proppants, fibers, or nanoparticles suspended in the solution.

### TECHNICAL FIELD

The present invention relates in general to enhanced oil recovery (“EOR”), and in particular, to imaging of subterranean reservoirs, which may contain hydrocarbons.

### BACKGROUND AND SUMMARY

Energy consumption worldwide is expected to increase by 50% relative to current levels by the end of 2030 (K. Xiangling et al., Abu Dhabi international petroleum exhibition and conference, 2010, DOI 10.2118/138241-MS). This growth is unlikely to be met by renewable resources, and thus there is a strong and growing demand for oil as a predominant energy resource. Primary and secondary oil recovery methods typically produce only 15-30% of the original oil in place, depending on the compressibility of fluids and initial pressure of the reservoir (D. Green et al., Henry L. Doherty Memorial Fund of AIME, Society of Petroleum Engineers, 1998). This leaves large amounts of trapped oil in reservoirs which in some cases is amenable to tertiary or enhanced oil recovery (“EOR”) processes.

EOR processes aim to recover trapped oil left in reservoirs after primary and secondary recovery methods. New materials and additives are needed to make EOR economical in challenging reservoirs or harsh environments. Nanoparticles have been widely studied for EOR processes, including for imaging such reservoirs. For imaging purposes in biomedicine, magnetic nanoparticles have been used for enhanced magnetic resonance imaging (“MRI”) and magnetic particle imaging (“MPI”).

MRI is one of the most powerful non-invasive imaging techniques used in clinical medicine today. The method is based on the different relaxation times of hydrogen atoms. Magnetic nanoparticles can be used as enhanced MRI contrast agents because they can increase the diagnostic sensitivity and specificity due to modifications of relaxation time of the protons. More specifically, the magnetic nanoparticles shorten both the longitudinal and transverse relaxation of surrounding protons. MRI contrast relies on the differential uptake of different tissues. The first dextran coated iron oxide nanoparticle was officially registered 16 years ago as a contrast agent for an MRI of liver in Europe (M. Kresse et al., Scientific and Clinical Applications of Magnetic Carriers, New York: Plenum Press, pg. 545, 1997). The efficiency of iron oxide nanoparticles as contrast agents in various tissues depends on their physiochemical properties such as size, charge, and coating (C. Chouly et al., Development of superparamagnetic nanoparticles for MRI: effect of particle size, charge and surface nature on biodistribution, J. Microencapsulation 13 (3), pgs. 245-255, 1996), and can be augmented through surface modifications by biologically active substances (e.g., antibodies, receptor ligands, proteins, etc.) (W. Schütt et al., Applications of Magnetic Targeting in Diagnosis and Therapy—Possibilities and Limitations: A Mini-Review, Hybridoma 16 (1): pgs. 109-117, February 1997; J. W. M. Bulte et al., Scientific and Clinical Applications of Magnetic Carriers, New York: Plenum Press, p. 527, 1997; and Y. Zhang et al., Magnetic resonance imaging detection of rat renal transplant rejection by monitoring macrophage infiltration, Kidney International 58, pgs. 1300-1310, 2000). The effects of magnetic nanoparticle composition and size on proton relaxation have been evaluated empirically with iron oxides (L. Josephson et al., The effects of iron-oxides on proton relaxivity, Magnetic Resonance Imaging 6, pgs 647-653, 1988; and Y. W. Jun et al., Nanoscale size effect of magnetic nanocrystals and their utilization for cancer diagnosis via magnetic resonance imaging, Journal of the American Chemical Society 127, pgs. 5732-5733, 2005). For instance, nanoparticles with diameters of 30 nm or more are rapidly collected by the liver and spleen, while particles with sizes of 10 nm or less are not easily recognized. Since the smaller particles have longer half-life in the blood stream, they have been used to visualize the vascular system (R. Weissleder et al., Ultrasmall superparamagnetic iron oxide: characterization of a new class of contrast agents for MR imaging. Radiol, 175, pgs. 489-493, 1990; S. G. Ruehm et al., Magnetic resonance imaging of atherosclerotic plaque with ultrasmall superparamagnetic particles of iron oxide in hyperlipidemic rabbits, Circulation 103, pgs. 415-422, 2001; and F. K. Wacker et al., MR image-guided endovascular procedures with the ultrasmall superparamagnetic iron oxide SHU555C as an intravascular contrast agent: study in pigs. Radiology 226, pgs. 459-464, 2003). Moreover, some tumor cell relaxation times are not altered by these contrast agents. This effect can be used to help identify malignant liver and brain tumors (S. C. A. Michel et al., Preoperative breast cancer staging: MR imaging of the axilla with ultra-small superparamagnetic iron oxide enhancement, Radiology 225, pgs. 527-536, 2002; R. C. Semelka et al., Contrast agents for MR imaging of the liver, Radiology 218, pgs. 27-38, 2001; and W. S. Enochs et al., Improved delineation of human brain tumors on MR images using a long-circulating, superparamagnetic iron oxide agent, Journal of Magnetic Resonance Imaging 9, pgs. 228-232, 1999). In general, the resolution of MRI can be enhanced to such an extent that even single cells could be detected (T. Neuberger et al., Superparamagnetic nanoparticles for biomedical applications: Possibilities and limitations of a new drug delivery system, Journal of Magnetism and Magnetic Materials 293, pgs. 483-496, 2005). The magnetic nanoparticles have already been used as contrast MRI agents also for cancer imaging (e.g., solid tumors) and cardiovascular imaging (R. C. Semelka et al., Contrast agents for MR imaging of the liver, Radiology 218, pgs. 27-38, 2001; M. G. Harisinghani et al., Sensitive, noninvasive detection of lymph node metastases, PLoS Medicine 1. e66, 2004; W. S. Enochs et al., Improved delineation of human brain tumors on MR images using a long-circulating, superparamagnetic iron oxide agent, Journal of Magnetic Resonance Imaging 9, pgs. 228-232, 1999; E. A. Neuwelt et al., Imaging of iron oxide nanoparticles by MR and light microscopy in patients with malignant brain tumors, Neuropathology and Applied Neurobiology 30, pgs. 456-471, 2004; D. E. Sosnovik et al., Molecular magnetic resonance imaging in cardiovascular medicine, Circulation 115, pgs. 2076-2086, 2007; and S. A. Wickline et al., Molecular imaging and therapy of atherosclerosis with targeted nanoparticles, Journal of Magnetic Resonance Imaging 25, pgs. 667-680, 2007). They can also be used for molecular imaging due to their ability to serve as molecularly targeted imaging agents and resolve dimensions beyond the detection threshold of many other imaging techniques (M. G. Harisinghani et al., Noninvasive detection of clinically occult lymph-node metastases in prostate cancer, New England Journal of Medicine 348, pgs. 2491-2499, 2003; R. Weissleder et al., Molecular imaging, Radiology 219, pgs. 316-333, 2001; and R. Weissleder, Molecular imaging in cancer, Science 312, pgs. 1168-1171, 2006). Superparamagnetic iron oxide nanoparticles can also be used as combined carrier systems for drug delivery while at the same time serving as contrast agents (J. W. M. Bulte et al., Scientific and Clinical Applications of Magnetic Carriers, New York: Plenum Press, pg. 527, 1997). Using this technique, the behavior of the pharmaceutical agent could be monitored by means of MRI. Further, distribution of particles can be influenced through the application of an external magnetic field.

Another imaging modality in which magnetic nanoparticles are used is called Magnetic Particle Imaging (“MPI”) (Q. A. Pankhurst et al., Progress in applications of magnetic nanoparticles in biomedicine, J. Phys. D: Appl. Phys., vol. 42: 224001 (15 pages), 2009). This technique was first developed by Gleich and Weizenecker from Philips Research in Hamburg (B. Gleich et al., Tomographic imaging using the nonlinear response of magnetic particles, Nature, vol. 435, pgs. 1214-1217, 2005). The proposed method is based on the nonlinearity of the magnetization curve of the magnetic nanoparticles. The idea is that if the experiment is designed to work at the nonlinear part of the curve with magnetic fields far below saturation, the measured signal contains harmonics of the excitation signal. However, if the operation point is at the saturation regime, harmonics of the exciting oscillating field are almost non-existent. Therefore, in the presence of a large enough DC magnetic field, the magnetization curve is flat, and as such the harmonic signals disappear. The result of this simple concept is that if a DC field is applied to all but a small area of the sample (a.k.a “field-free point”), the only harmonic signal received comes from that field-free point, and all other signals coming from other points of the sample are damped out (i.e., they do not exhibit large enough harmonics to be measured). This technique is superior to MRI for two reasons. The first reason is that the sensitivity of imaging is improved as the signal is virtually unattenuated by intervening tissue. The second advantage of this technique over MRI is that there is no need to place the specimen in a total-surround scanner. Only a single-sided scanner is sufficient for imaging in this technique, with a resolution of 1 mm.

Cross-well electromagnetic (“EM”) induction tomography utilizing cross-well EM measurements is emerging as a key reservoir characterization and monitoring tool that enables greater understanding of reservoir heterogeneity and fluid front monitoring over time (B. Marion et al., Cross-well Technologies: New Solutions for Enhanced Reservoir Surveillance, Paper SPE 144271 presented at the SPE Enhanced Oil Recovery Conference, Kuala Lumpur, Malaysia, Jul. 19-21, 2011, DOI: 10.2118/144271-MS). Cross-well EM tomography has the potential to provide fluid distribution mapping at the interwell scale, and thus can be used for identification of bypassed hydrocarbon, monitoring macroscopic sweep efficiency, planning infill drilling, and improving effectiveness of reservoir simulation (M. L. Sanni et al., Cross-well Electromagnetic Resistivity Tomography: Pushing the Limits, Paper SPE 105353 presented at the 15th SPE Middle East Oil & Gas Show and Conference, Bahrain, March 11-14, 2007, DOI: 10.2118/105353-MS). While traditional well log data provide high resolution measurements of the formation very close to the wellbore, surface-based methods provide a larger volume of investigation but coarser resolution. Cross-well measurements bridge the gap by imaging the interwell region at the reservoir scale (B. Marion et al., Cross-well Technologies: New Solutions for Enhanced Reservoir Surveillance, Paper SPE 144271 presented at the SPE Enhanced Oil Recovery Conference, Kuala Lumpur, Malaysia, Jul. 19-21, 2011, DOI: 10.2118/144271-MS). It should be noted that all applications of cross-well EM tomography thus far are exclusively based on the conductivity contrast in the formation. In this disclosure, magnetic permeability contrast is detected using the EM cross-well technology.

A cross-well EM system may utilize a transmitter in one well that broadcasts a time varying magnetic field in the three-dimensional (“3D”) region surrounding the boreholes, and multiple receivers that detect the field in another well some distance away from the first. The recorded magnetic fields are a combination of the primary field of the transmitter and the secondary fields produced by currents induced in the electrically conductive formation. The relative ratio of scattered to primary magnetic field increases with increasing conductivity, frequency, and borehole separation. The sources and receivers may be placed at regularly spaced intervals below, within, and above the depth range of interest (D. L. Alumbaugh et al., Multi-scale data integration in Cross-well EM imaging and interpretation, Proc., Society of Exploration Geophysics (SEG) Annual Meeting, Las Vegas, Nev., Nov. 9-14, 2008.). The collected data are interpreted via an inverse technique whereby an initial model is constructed mainly through logs and background geology, and the inversion adjusts the model until the observed and calculated data fit within a given tolerance. This process results in building an image of the interwell conductivity structures (B. Montaron et al., Shapes of Flood Fronts in Heterogeneous Reservoirs and Oil Recovery Strategies, Paper SPE 111147 presented at the SPE/EAGE Reservoir Characterization and Simulation Conference, Abu Dhabi, UAE, Oct. 28-31, 2007, DOI: 10.2118/111147).

This geometry provides high resolution resistivity (and/or conductivity) distribution of the subsurface between the wells. When obtained at different time steps during injection and production, this resistivity distribution provides valuable information that can be integrated with other data to interpret the changes in the reservoir rock and distribution between the wells. These data are valuable in updating the reservoir model with reduced uncertainty and enhanced predictability (B. Marion et al., Cross-well Technologies: New Solutions for Enhanced Reservoir Surveillance, Paper SPE 144271 presented at the SPE Enhanced Oil Recovery Conference, Kuala Lumpur, Malaysia, Jul. 19-21, 2011, DOI: 10.2118/144271-MS).

The basic theory for the use of low frequency cross-well EM methods for determining conductivity distribution between boreholes on a scale useful for reservoir characterization has been developed and detailed in a series of papers by Zhou et al. (Q. Zhou et al., Audio-frequency electromagnetic tomography in 2-D, Geophysics 58 (4): pp. 482-495. 1993), Alumbaugh and Morrison (D. L. Alumbaugh et al., Monitoring subsurface changes over time with cross well electromagnetic tomography, Geophysical Prospecting, vol. 43, pp. 873-902, 1995; and D. L. Alumbaugh et al., Theoretical and practical considerations for cross-well electromagnetic tomography using a cylindrical geometry, Geophysics, vol. 60, pp. 846-870, 1995), Spies and Habashy (B. Spies et al., Sensitivity analysis of cross-well electromagnetics, Geophysics, vol. 60, pp. 834-845, 1995), and Wilt et al. (M. J. Wilt et al., Cross-well Electromagnetic Tomography: System Design Considerations and Field Results, Geophysics, vol. 60 (3), pp. 871-885, 1995). The work of Zhou (Q. Zhou, Audio frequency numerical modeling and tomographic inversion for reservoir evaluation: Ph.D. thesis, Univ. of California, Berkeley, 1989) initiated a systematic study of low-frequency cross-well EM for reservoir scale problems and showed that a low-frequency analog of seismic diffraction tomography provided good resolution for interwell features. Wilt et al. (1995) subsequently developed instrumentation possessing adequate power for moderate to high-resolution imaging, using boreholes spaced up to 500 m apart. Their initial field experiment was undertaken at the Devine test site in Texas. They conducted another field experiment at the University of California's Richmond field and could track an injected slug of salt water using conductivity images before and after injection. Their displayed examples showed that subsurface conductivity imaging is feasible with cross-well EM induction. Alumbaugh et al. (1995) proved that vertical resolution improves with increasing frequency and spatial sampling density. They also claimed that greater conductivity contrasts between the target and the background can result in better resolution. The results are critically dependent on the transmitter-receiver spacings, and because of the strong attenuation, also on the noise model.

Spies and Habashy (1995) conducted sensitivity analyses for low-frequency cross-well EM and showed that the region contributing to the response is quasi-ellipsoidal and encompasses both source and receiver. The strongest response originates from the immediate vicinity of source and receiver. Contributions from the interwell region, although measurable, have a much smaller effect on the response. However, with increasing frequency, the sensitivity of the results to the interwell region increases as well. They also showed that interpretation is improved by combining measurements at different frequencies by using multi-component receivers.

Several researchers studied the effect of steel-cased wells on the cross-well EM response. They all report magnificent signal attenuation due to the presence of the casing. Nekut (A. J. Nekut, Cross-well electromagnetic tomography in steel-cased wells, Geophysics, vol. 60 (3), pp. 912-920, 1995) showed that steel-cased wells completed or retrofitted with insulating gaps offer a stable, low-cost, permanent set of electrodes to implement long-term monitoring of petroleum reservoir fluid movements using EM tomography technology. Wilt et al. (M. J. Wilt et al., Crosshole EM in steel-cased boreholes, Proc., Society of Exploration Geophysics (SEG) Annual Meeting, Denver, Colo., Oct. 6-10, 1996) showed that crosshole measurements could be effective from the fiberglass well to any steel-cased well located within a few hundred meters of the transmitter. They also showed that attenuation of the signal due to the presence of casing increases with increasing frequency. Therefore, there is a trade-off between casing effect attenuation and higher resolution with increasing frequency. In addition, their results indicate that casing effect is quite local, most likely due to the pipe immediately surrounding the sensor.

Bhatti et al. (Z. Bhatti et al., Imaging Injected Water flood Fronts between Wells in a Complex Carbonate Reservoir: Designing Completions to Optimize Image Resolution, Paper SPE 111174 presented at the SPE/EAGE Reservoir Characterization and Simulation Conference, Abu Dhabi, UAE. Oct. 28-31, 2007, DOI: 10.2118/111174) demonstrated the application of the cross-well EM technique to a pilot in United Arab Emerites. They also showed the benefit of using the optimized casing material on the resolution of cross-well EM resistivity images. Furthermore, these researchers described the methods they employed for monitoring the fluid flow and illustrated the preliminary results of their modeling process. Their pre-job simulations concluded that 1) cross-well EM resistivity technique is well suited for tracking the water front in their reservoir conditions, 2) the injected fluids created sufficient conductivity contrast to be sensed by the technique, and 3) the flood front propagation could be captured by conducting the surveys in a time-lapse mode. Montaron et al. (B. Montaron et al., Shapes of Flood Fronts in Heterogeneous Reservoirs and Oil Recovery Strategies, Paper SPE 111147 presented at the SPE/EAGE Reservoir Characterization and Simulation Conference, Abu Dhabi, UAE, Oct. 28-31, 2007, DOI: 10.2118/111147) illustrated the application of the cross-well EM technique for reservoir characterization in China's Gudao oil field. The cross-well survey was designed to help better understand the waterflood dynamics and locate bypassed reserves, thereby improving reservoir definition in the mentioned oil field.

Sanni et al. (M. L. Sanni et al., Cross-well Electromagnetic Resistivity Tomography: Pushing the Limits, Paper SPE 105353 presented at the 15th SPE Middle East Oil & Gas Show and Conference, Bahrain, Mar. 11-14, 2007, DOI: 10.2118/105353-MS) carried out extensive pre-job forward modeling to investigate the feasibility of obtaining useful results with a proposed cross-well system in a carbonate reservoir in Saudi Arabia. The interwell spacing was at the upper limit of the operating envelope allowed by the EM technology of that time, circa 1000 m. They obtained encouraging results from the simulations. They could successfully detect edge water due to highly permeable layers or fracture swarms, bottom water encroachment, coning, etc. They also evaluated optimal operating frequency of the system transmitter as well as necessary extension of logging depth below and above the zone of interest for optimal aperture and data resolution.

DePavia et al. (L. DePavia et al., Next Generation Cross-well EM Imaging Tool, Paper SPE 116344 presented at the SPE Annual Technical Conference and Exhibition, Denver, Colo., Sep. 21-24, 2008. DOI: 10.2118/116344-MS) developed and field-tested a new cross-well EM system. Their system possesses several advantages over earlier systems including larger moment of the open-hole transmitter and smaller-diameter receivers with similar sensitivity. The tool also enables higher sampling rate, faster logging speed, and wireless GPS synchronization. A software package with improved data processing flow also accompanies the tool. Finally, a field test was conducted with different operation frequencies for multiple data resolutions in open-hole conditions. The field test results indicated that the higher-frequency data set provides higher-resolution inverted resistivity images between the wells as does using a priori information to build the starting model.

Bhatti et al. (Z. Bhatti et al., Tracking Interwell Water Saturation in Pattern Flood Pilots in a Giant Gulf Oil field, Paper SPE 118434 presented at the Abu Dhabi International Petroleum Exhibition and Conference, Abu Dhabi, UAE, Nov. 3-6, 2008, DOI: 10.2118/118434) applied the cross-well EM method to a water injection pilot initiated by ADCO and measured the interwell resistivity distribution between the observation wells at the pilots. They briefly described the pilot design and the detailed geological model and showed cross-well EM results from the initial set of baseline and time lapse data sets. Recently, Marion et al. (B. Marion et al., Cross-well Technologies: New Solutions for Enhanced Reservoir Surveillance, Paper SPE 144271 presented at the SPE Enhanced Oil Recovery Conference, Kuala Lumpur, Malaysia, Jul. 19-21, 2011, DOI: 10.2118/144271-MS) showed, through investigating two case studies, that integrating cross-well seismic and cross-well EM measurements into modeling workflow offers helpful insight into reservoir structure and fluid movement in the formation. Their discussion particularly focuses on diagnostic capabilities of using cross-well seismic and EM and their sensitivity to steam injection processes.

Stable dispersions of single-domain ferro- or ferri-magnetic nanoparticles have immense potential in geological subsurface applications, such as those that contain or potentially contain hydrocarbons (also referred to as “reservoirs”). The specially surface-coated nanoparticles are capable of flowing through micron-size pores across a long distance in the reservoir with minimal retention in rock. The engineered superparamagnetic nanoparticles change the magnetic permeability of the flooded region, when added to the injected fluid during secondary and enhanced oil recovery processes. By solving Maxwell's equations for different flow conditions, embodiments of the present invention model the propagation of such a “ferrofluid” slug in a reservoir and its response to a cross-well electromagnetic (“EM”) tomography system.

Embodiments of the present invention distinguish the injected and resident fluids when they have similar conductivities by tracking the perturbations caused by the presence of superparamagnetic nanoparticles to the EM measurements. The EM response to these magnetic contrast agents can thus help characterize the formation and the fluid displacement mechanisms and learn more about the reservoir and its dynamics than conventional EM tomography.

From the EM simulations, detectability of the ferrofluid slug is quantified as a function of the distance from the injection point (and magnetic source) in the reservoir. This distance depends on various parameters such as applied frequency, initial volume of injected ferrofluid and its current location in the reservoir, reservoir thickness, and the interplay between conductivity and magnetic permeability of the flooded zone. Increasing the frequency results in magnetic resolution enhancement, but increases conductivity loss, which reduces the radial depth of investigation. The measured EM signal may also be quite sensitive to hydrodynamic dispersion. Reservoir dispersivity may be deduced from EM measurements. Various reservoir application possibilities of the EM sensing of superparamagnetic nanoparticles are then described, though embodiments of the present invention are applicable with utilization of magnetic particles in micron sizes.

Embodiments of the present invention enhance the imaging capability of cross-well electromagnetic tomography with use of superparamagnetic nanoparticles so that the location of the oil displacement fluids in subsurface formations can be more accurately tracked. Embodiments of the present invention also evaluate, diagnose, and map hydraulic fractures induced in subsurface formations for production enhancement. The superparamagnetic nanoparticles create a contrast in magnetic susceptibility of the affected formation. The contrast can be efficiently detected utilizing the electromagnetic equipment technology currently in use in oil and gas industry. The method can also be used to detect the remaining oil in place (“ROIP”) left after ordinary waterfloods, or to determine the extent and boundaries of fracture networks, due to the susceptibility's significant sensitivity to reservoir heterogeneity (e.g., rock permeability and fluids saturation). The measurements acquired in this way exhibit a much more enhanced resolution over those obtained via conventional electromagnetic tomography, especially at the very early stages of the flood and at very low frequencies.

Advantages of embodiments of the present invention include the injection of superparamagnetic nanoparticles (or magnetic particles of micron sizes) into the subsurface formation for the purpose of enhanced imaging of the distribution of oil in the reservoir. Further advantages of embodiments of the present invention include operation at very low frequencies, which significantly reduces attenuation due to casing, and increases the probing depth.

The probing depth and the resolution for the detection of fluid distribution in reservoir rock is enhanced, especially at low frequencies and at early stages of the flood where the current electromagnetic tomography technology is limited. Further embodiments of the present invention evaluate and map hydraulic fractures created in subsurface formations for the purpose of well stimulation. No salinity alteration of the formation is required by the method in order to keep the formation damage minimized.

With the injection of an image-enhancing agent into the subsurface rock formation, the properties of the oil reservoirs can be measured more accurately and reliably, especially in situations where salinity alteration results in formation damage. Further, operating at low frequencies minimizes the noise and attenuation due to casing and rock formation, thereby increasing the probing depth.

Embodiments of the present invention may be also employed to detect the distribution of residual oil, or areal and vertical heterogeneity, in subsurface formations.

### BRIEF DESCRIPTION OF DRAWINGS

FIG. 1 illustrates a schematic of a process of oil displacement by an injection fluid.

FIG. 2A illustrates a schematic of an assumed two-dimensional (“2D”) axi-symmetric cross-well model, wherein the reservoir layer (e.g., approximately 20 meters (“m”) thick) is flooded with a ferrofluid slug followed by continuous brine injection, and an observatory well is approximately 100 m away from the source (circled).

FIG. 2B illustrates a schematic where the area marked with the circle in FIG. 2A is magnified, and wherein the source inside the borehole is in contact with the borehole fluid (i.e., water).

FIGS. 3A-3B show a comparison between numerical results and theory for a homogenous space, wherein FIG. 3A shows a comparison acquired along z (vertical coordinate) at a fixed r=100 m from the source, and wherein FIG. 3B shows a comparison acquired along a radial distance away from the source at a fixed z=0.

FIG. 4 illustrates a sensitivity of the z-component of magnetic field (Hz) to a continuous injection of brine, wherein the z-axis shows the relative change of the magnetic field with respect to measurements before injecting any fluid, wherein the x-axis corresponds to the vertical location along the observatory well (located at approximately 100 m away from the injection point), wherein the y-axis identifies the location of the propagating flood front. Any cross-section perpendicular to this axis corresponds to a well log at the observatory well. The cross-well signal exhibits minimal sensitivity to conductivity alteration as a result of brine injection.

FIG. 5 illustrates 3D sensitivity of cross-well measurements to the altered magnetic permeability of a formation as a result of propagation of a ferrofluid slug, wherein the z-axis identifies the relative change of the signal with respect to before flood case, and the y-axis identifies the location of the propagating ferrofluid slug. Any cross-section perpendicular to this axis corresponds to a well log at the observatory well. The x-axis shows the measurement location along the observatory wellbore. The measurements indicate the cross-well signal is sensitive to the location of the ferrofluid slug. The sensitivity of the measurements is maximum when the ferrofluid slug is either close to the transmitter or to the receiver with less sensitivity when the ferrofluid slug is somewhere in between the wells. Cross-well measurements acquired when the ferrofluid slug is close to the receiver array exhibit high sensitivity to the boundaries of the reservoir layer carrying the ferrofluid slug. FIG. 5(a) shows results for μᵣ=1.25, FIG. 5(b) shows results for μᵣ=1.50, FIG. 5(c) shows results for μᵣ=1.75, and FIG. 5(d) shows results for μᵣ=2.00.

FIG. 6 illustrates 2D sensitivity of cross-well measurements to the altered magnetic permeability of a formation as a result of propagation of a ferrofluid slug, wherein the vertical z axis corresponds to measurement locations along the observation well, and the horizontal axis identifies the location of the ferrofluid slug. The measurements indicate the cross-well signal is sensitive to the location of the ferrofluid slug. The sensitivity of the measurements is maximum when the ferrofluid slug is either close to the transmitter or to the receiver with less sensitivity when the ferrofluid slug is somewhere in between the wells. Cross-well measurements acquired when the terrofluid slug is close to the receiver array exhibit high sensitivity to the boundaries of the reservoir layer carrying the ferrofluid slug. FIG. 6(a) shows results for μᵣ=1.25. FIG. 6(b) shows results for μᵣ=1.50. FIG. 6(c) shows results for μᵣ=1.75, and FIG. 6(d) shows results for μᵣ=2.00.

FIG. 7 illustrates the sensitivity of a cross-well measurements at z=0 to the altered magnetic permeability of the ferrofluid-flooded region as a function of the radial location of the ferrofluid slug. Large sensitivity is achieved when the ferrofluid slug is near the transmitter or the receiver with suppressed sensitivity in between the wells. For larger magnetic permeability, larger sensitivity is achieved.

FIG. 8 illustrates 3D sensitivity of single-well measurements to the altered magnetic permeability of a formation as a result of propagation of a ferrofluid slug, wherein the z-axis identifies the relative change of the signal with respect to before flood case, and wherein the y-axis identifies the location of the propagating ferrofluid slug. Any cross-section perpendicular to this axis corresponds to a well log at the injection well. The x-axis shows the measurement location along the injection wellbore. The measurements indicate the single-well signal is partially sensitive to the location of the ferrofluid slug. The measurements are only sensitive when the ferrofluid slug is close to the transmitter. Once the ferrofluid slug is away from the source, sensitivity is totally suppressed. However, single-well measurements acquired when the ferrofluid slug is close to the injection well exhibit high sensitivity to the boundaries of the reservoir layer carrying the ferrofluid slug. FIG. 8(a) shows results for μᵣ=1.25, FIG. 8(b) shows results for μᵣ=1.50, FIG. 8(c) shows results for μᵣ=1.75, and FIG. 8(d) shows results for μᵣ=2.00.

FIG. 9 illustrates 2D sensitivity of single-well measurements to the altered magnetic permeability of a formation as a result of propagation of a ferrofluid slug, wherein the vertical a axis corresponds to measurement location along the injection well, and the horizontal axis identifies the location of the ferrofluid slug. The measurements indicate the cross-well signal is sensitive to the location of the ferrofluid slug only when the ferrofluid is close enough to the transmitter. The sensitivity of the measurements is severely attenuated when the ferrofluid slug is far from the injection wellbore, inside which the sensors are deployed. Single-well measurements acquired when the ferrofluid slug is close to the injection point, however, are sensitive to the boundaries of the reservoir layer carrying the ferrofluid slug (at z=±10). FIG. 9(a) shows results for μᵣ=1.25, FIG. 9(b) shows results for μᵣ=1.50, FIG. 9(c) shows results for μᵣ=1.75, and FIG. 9(d) shows results for μᵣ=2.00.

FIG. 10 illustrates sensitivity of single-well measurements at z=0 to the altered magnetic permeability of a ferrofluid-flooded region as a function of the radial location of the ferrofluid slug. Large sensitivity is achieved when the ferrofluid slug is near the transmitter with drastically suppressed sensitivity away from the source well. For larger magnetic permeability, larger sensitivity is achieved.

FIG. 11 illustrates relative change in magnetic field with respect to a before-flood case for single-well measurements acquired when the ferrofluid slug is located at the first annulus (cf. see FIG. 2). Measurements are significantly sensitive to the reservoir layer boundaries (e.g., at z=±10).

FIG. 12 illustrates a block diagram of a system and method configured in accordance with embodiments of the present invention.

FIG. 13A illustrates a block diagram of a system and method for determining EM properties of an EM fluid at the injection point.

FIG. 13B illustrates a block diagram of a system and method for determining and saving properties of the injected fluid for subsequent processes in embodiments of the present invention.

FIG. 14 illustrates a block diagram of a system and method for determining a static model of a formation using either well logs data or synthetic data provided by a user.

FIG. 15A illustrates a block diagram of a system and method for determining an EM properties distribution via coupling fluid-flow simulations and effective medium theory calculations.

FIG. 15B illustrates a block diagram of a system and method for hydraulic fracture imaging.

FIG. 16 illustrates a block diagram of a system and method for determining an EM response.

FIG. 17 illustrates a block diagram of a system and method for determining a reservoir characterization.

FIG. 18 illustrates a schematic of nanoparticles with a ferromagnetic core and coated with adsorbed dispersant molecules. Magnetic core radius may be about 80% of the particle radius. FIG. 18(a) illustrates a representation of such nanoparticles with no external magnetic field applied; FIG. 18(b) illustrates a representation of such nanoparticles in a presence of an external magnetic field, wherein the nanoparticles become oriented.

FIG. 19 illustrates a schematic of a cross-well system with injected ferrofluid, a reservoir layer, shale, and wells indicated with solid black vertical lines. Fluid is injected from the left well. The signal is collected at the sensing well highlighted with the dashed rectangle. The source, identified with a dot, is located at the injection (left) well.

FIG. 20 illustrates a schematic of an EM illumination system configured in accordance with embodiments of the present invention.

FIG. 21 shows an example of a resistivity image from a cross-well survey (see World Oil March 2009, Vol. 230, No 3; http://www.worldoil.com/March-2009-Recent-advances-in-well-logging-and-formation-evaluation.html).

FIG. 22 illustrates an exemplary data processing system for implementing embodiments of the present invention.

### DETAILED DESCRIPTION

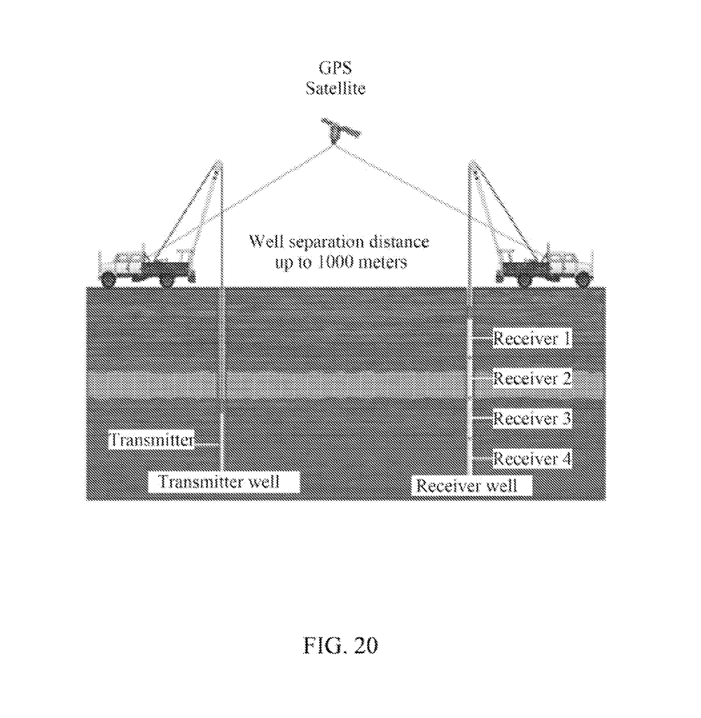

Magnetic iron oxide (“IO”) nanoparticles (“NPs”) have been designed for magnetic separations and for biological applications including medical imaging, drug targeting, and biomolecular separation on the basis of their unique electrical, magnetic, and chemical properties. Recently, major research efforts are underway on the utilization of superparamagnetic NPs as contrast agents for electromagnetic imaging of subsurface reservoirs, for example cross-well electromagnetic (“EM”) tomography. In an exemplary system such as illustrated in FIG. 20, an electromagnetic field generated in the source well is sensed in a secondary well. After inversion of the signal using Maxwell's equations for the electrical and magnetic fields, the spatial distribution of the electromagnetic field is obtained. A dispersion of superparamagnetic NPs may be injected into an oil reservoir, whereby the bank of the injected nanoparticles perturbs the electromagnetic fields in cross-well EM tomography. From the perturbation, the spatial distribution of the injected nanoparticles may be deduced to “illuminate” the flow pathways in the reservoir. With this technology, a dispersion of superparamagnetic NPs with a sufficiently high magnetic susceptibility is utilized to provide contrast enhancement. The magnetic properties of the IO in aqueous media are highly dependent upon the crystalline structure and particle size, which can be controlled by tuning of the reaction chemistry and the colloidal interactions during synthesis.

Embodiments of the present invention provide a system and process for tracking a flood front and illuminating fracture networks utilizing magnetic particles when exposed to electromagnetic (“EM”) illumination. In some embodiments, a ferrofluid slug chased by brine is tracked, and the electromagnetic response is monitored as the slug is propagating from the injection point toward the observation point. Embodiments of the present invention are applicable to cross-well and/or single well responses.

Some measurements may be determined using a COMSOL RF module, which is publically available at http://www.comsol.com/products/rf/, which is hereby incorporated by reference herein.

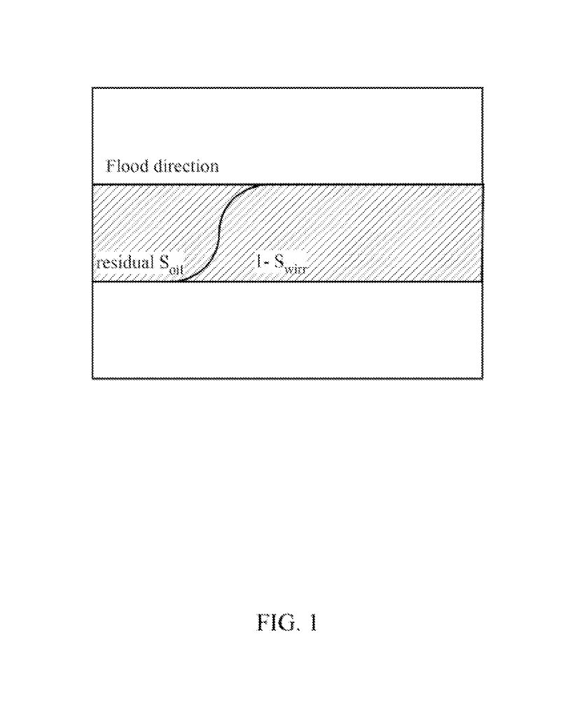

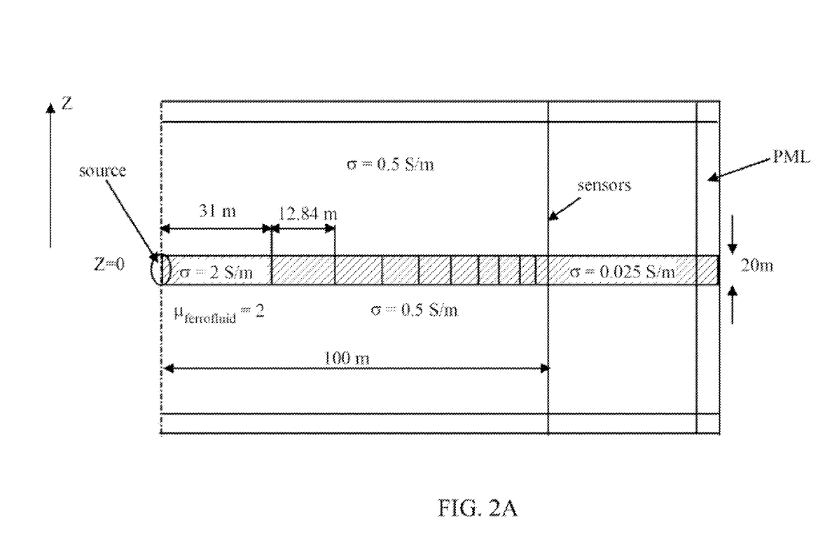

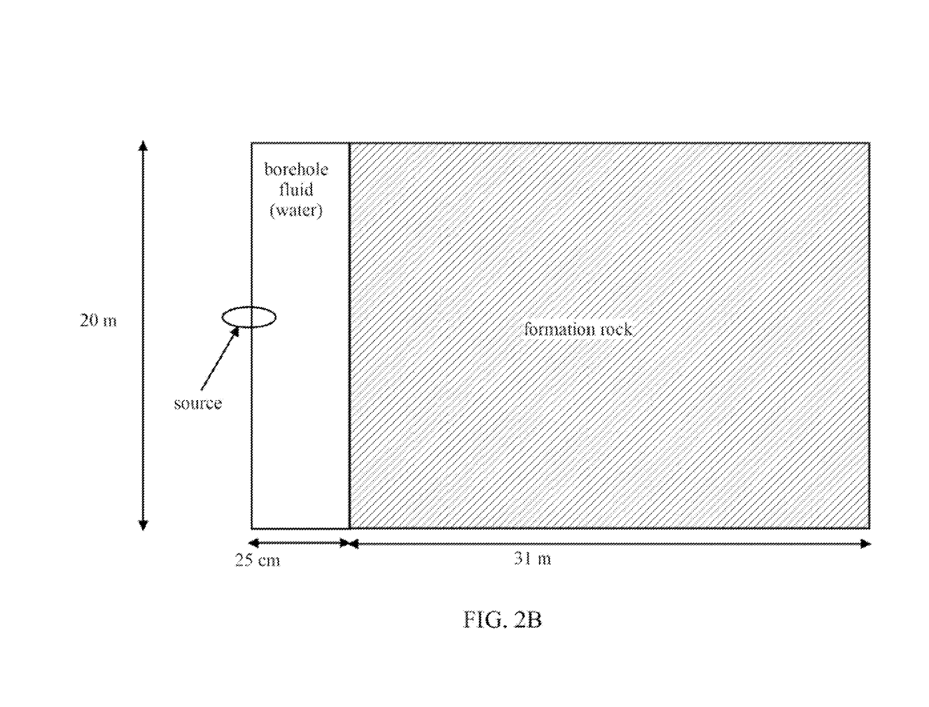

For purposes of describing embodiments of the present invention, the following disclosure utilizes an exemplary model having the displacement of oil by the injection fluid in an oil-bearing 30% porous reservoir, such as illustrated in FIG. 1. The irreducible water saturation and the residual oil saturation are both assumed to be 0.1. Assumed for the model is a 2D radially axi-symmetric model, such as illustrated in FIG. 2A. Future goal is to develop a full 3D model. The dashed line at the very left of FIG. 2A identifies the axis of symmetry of the model as well as the injection wellbore. The distance between the injection and the observation wells is assumed to be 100 meters. The interwell region is divided into 10 equi-voluminal annuli. The source is assumed to be a point magnetic dipole with a magnetic moment of 10,000 A·m² (see Wilt et al. 1995 previously referenced) operating at a frequency of 10 Hz and is located at z=0. The casing of both injection and observatory wells is assumed to be non-conductive and non-magnetic. Based on the low assumed frequency, this assumption is a reasonable one. It is known that at sufficiently low frequencies (e.g., less than 10 Hz), the type of casing material has minimal effect on the electromagnetic response (see Wilt et al. 1996 previously referenced). Hydrodynamic dispersion is initially ignored. The conductivity values, including that of the background, oil bearing reservoir layer and the waterflooded region are based on Dutta et al. (S. M. Dutta et al., Novel Borehole System for Reservoir Monitoring Using Transient Electromagnetics, Paper SPE 142510 presented at the SPE Middle East Oil and Gas Show and Conference, Manama, Bahrain, Sep. 25-28, 2011, DOI: 10.2118/142510-MS). Table I lists salt concentrations at different temperatures consistent with the conductivity values of the water flooded region. The salinity of the injection fluid is assumed to be similar to that of the resident fluid. The reservoir layer is assumed to be 20 m and the cross-well distance is 100 m, respectively. The computation domain extends radially to 500 m. In the vertical direction, it extends to +500 m upwards and to −500 m downwards. The PML (“perfectly matched layer”) is 50 m surrounding all the boundaries. FIG. 2B illustrates the region right in the vicinity of the source circled in FIG. 2A. It is to be noted in the figure that the ferrofluid does not contact the source at the initial stage of the waterflood. Instead, the source is surrounded by the borehole fluid (e.g., water in this case).

TABLE 1

| Celsius | ppm |
|---|---|
| 100 | 70586 |
| 110 | 64239 |
| 120 | 58919 |
| 130 | 54397 |
| 140 | 50508 |
| 150 | 47127 |

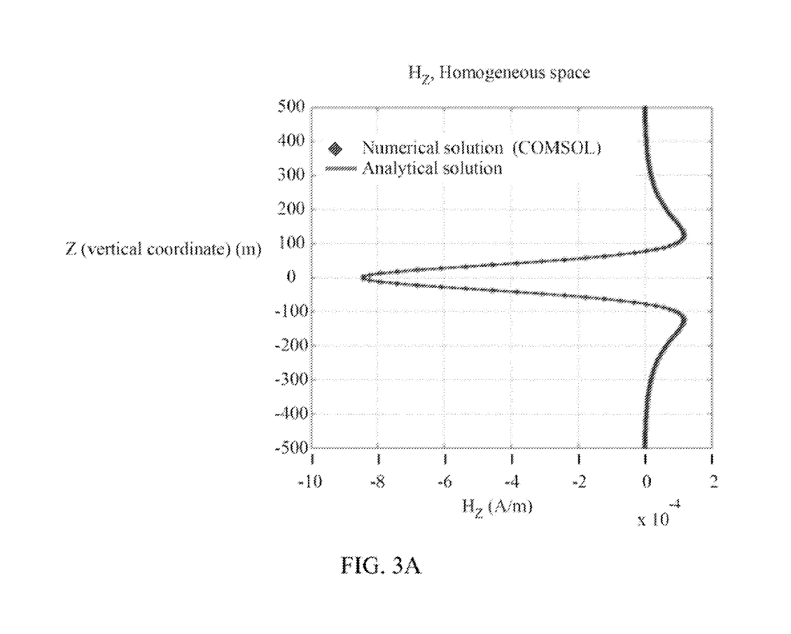

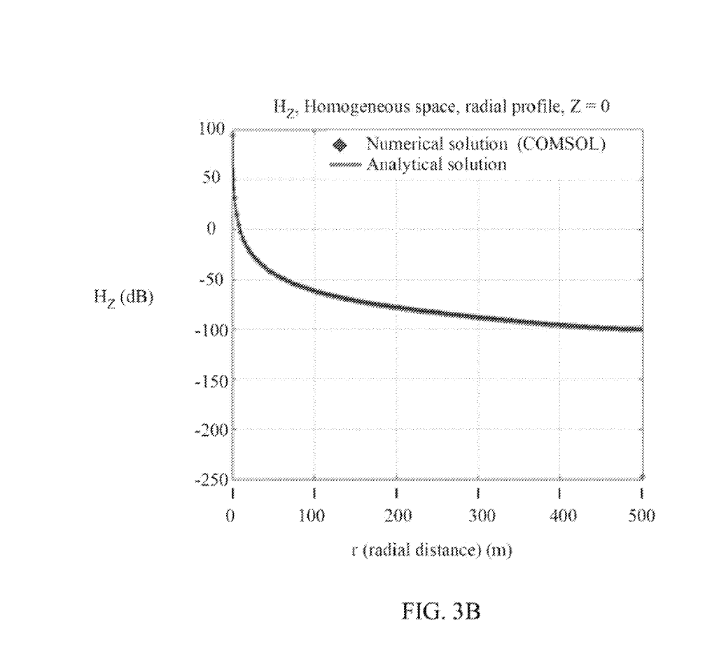

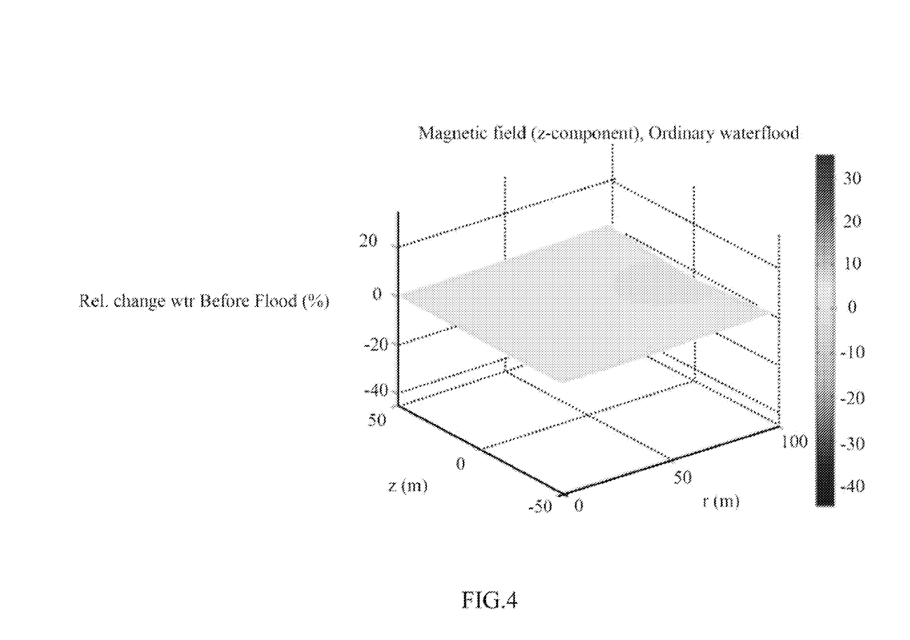

FIGS. 3A-3B compare the numerical results obtained from COMSOL based on the model illustrated in FIG. 2A with an analytical solution for a homogeneous formation. In this comparison, the magnetic properties of the entire model are set to the following values: conductivity (σ)=0.5 S/m (background conductivity), relative magnetic permeability (μᵣ)=1, and relative electric permittivity (∈ᵣ)=1. For a homogeneous formation, analytical solutions already exist and extensively documented (Cheng 1989). FIG. 3A shows the comparison with radial distance fixed at 100 m and z varying between −500 m to 500 m, covering the entire vertical range of the domain. FIG. 3B shows the comparison at fixed z=0 with radial distance varying from 25 cm to 500 m. Both figures indicate satisfactory agreement between the numerical results and theory. Therefore, the mesh design, the boundary conditions, and the PML are selected appropriately.

Results:

Cross-Well Measurements:

Initially illustrated is a continuous brine injection without any ferrofluid injected into the reservoir. FIG. 4 shows the z-component of the magnetic field (Hz) at the location of the observatory well (e.g., 100 m away from the source) as a function of vertical distance along the wellbore. The z-component identifies the relative change of the signal with respect to a before-flood case, i.e., when there is no fluid injected into the formation. The x-axis corresponds to the vertical location along the observatory well (e.g., located at 100 m away from the injection point). The y-axis identifies the location of the propagating flood front. Any cross-section perpendicular to this axis corresponds to a well log at the observatory well. FIG. 4 indicates that the relative change never exceeds 1%, which is the measuring equipment resolution. Therefore, magnetic field is not sensitive to conductivity alteration as a result of continuous brine injection.

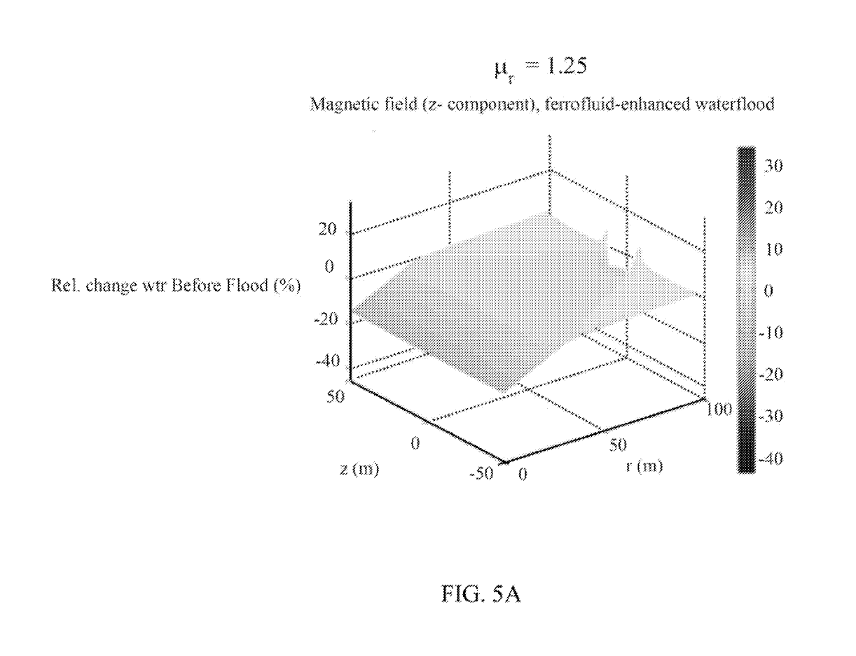

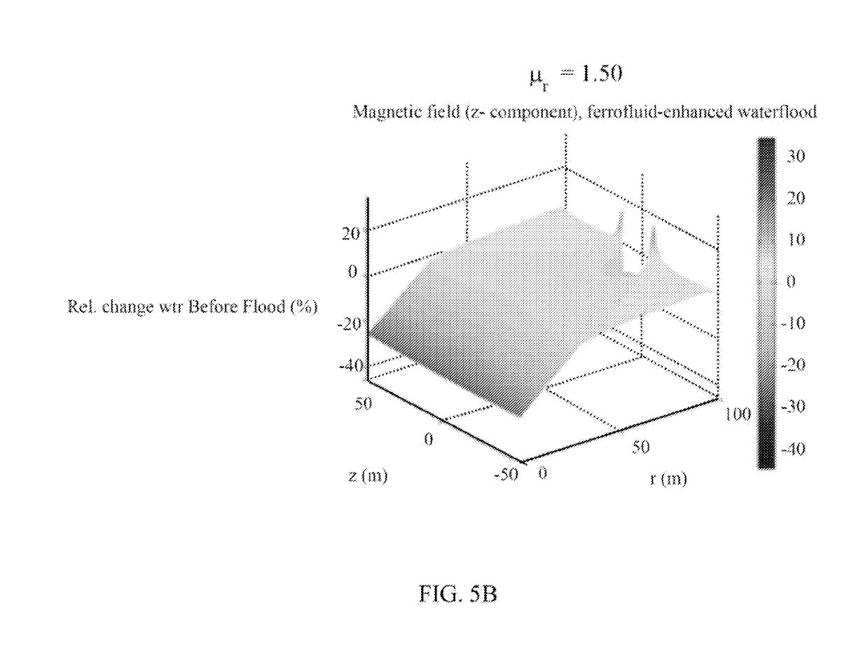

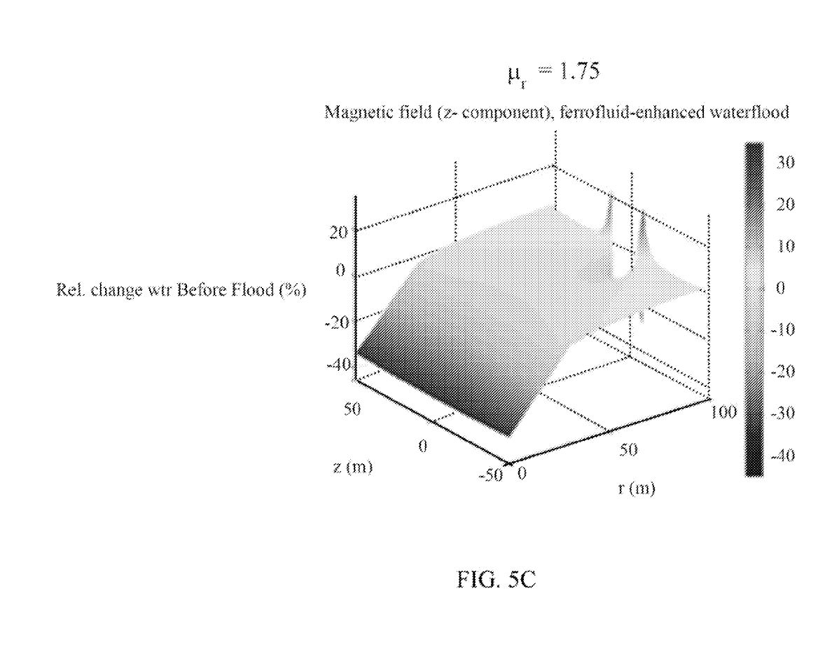

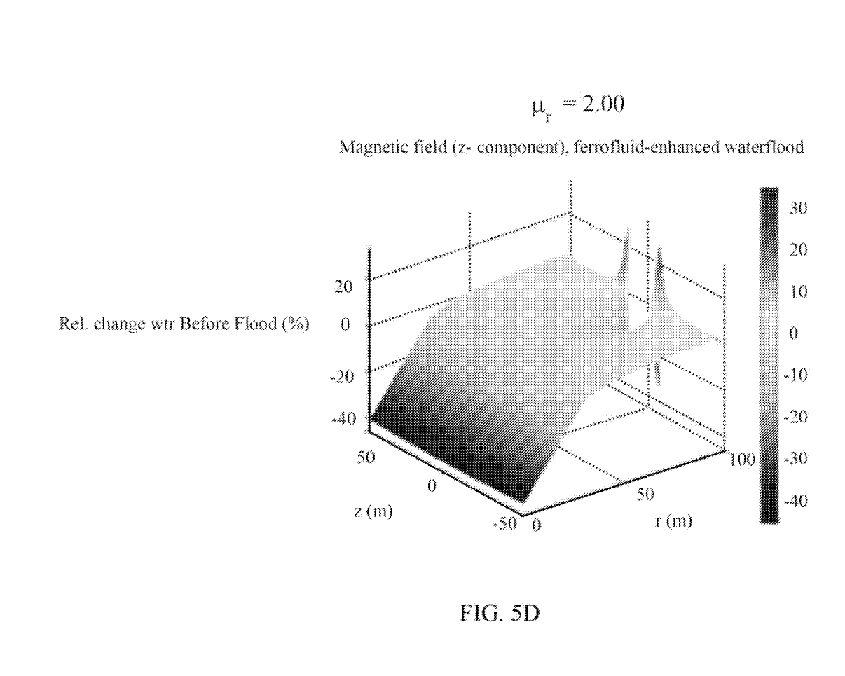

Next is illustrated a case when a ferrofluid slug is injected into the formation followed by continuous brine injection. This is performed for different values of the magnetic permeability of the affected formation; obtained is the sensitivity of the cross-well measurements (z-component of magnetic field, Hz) to the magnetic permeability of the ferrofluid-flooded region. FIG. 5 shows the sensitivity analysis. Similar to FIG. 4, in all of FIGS. 5(a)-(d), the z axis identifies the relative change of the signal with respect to the before-flood case, i.e., when there is no fluid injected into the formation. The y-axis identifies the location of the propagating ferrofluid slug. Any cross-section perpendicular to this axis corresponds to a well log at the observatory well. The x-axis shows the measurement location along the observatory wellbore.

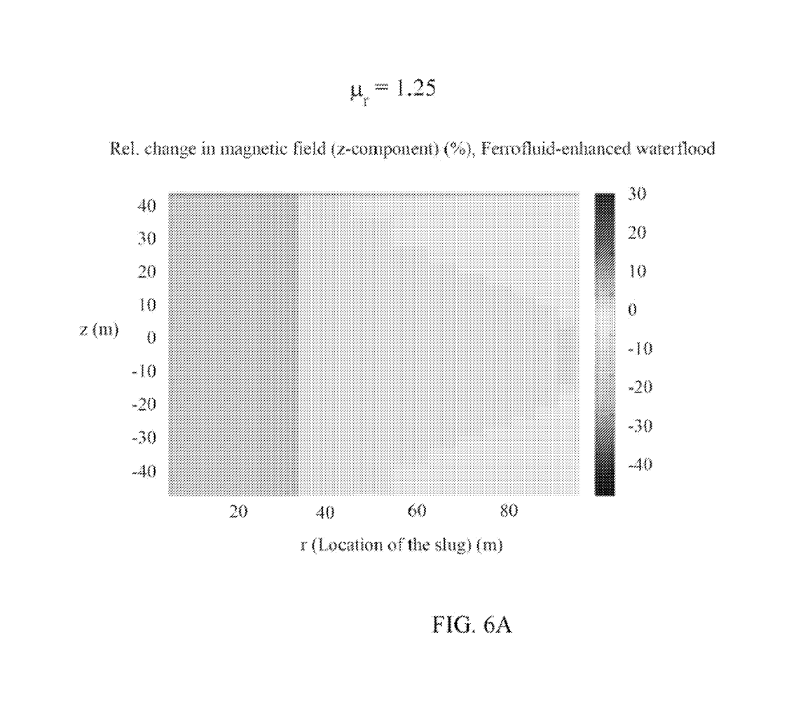

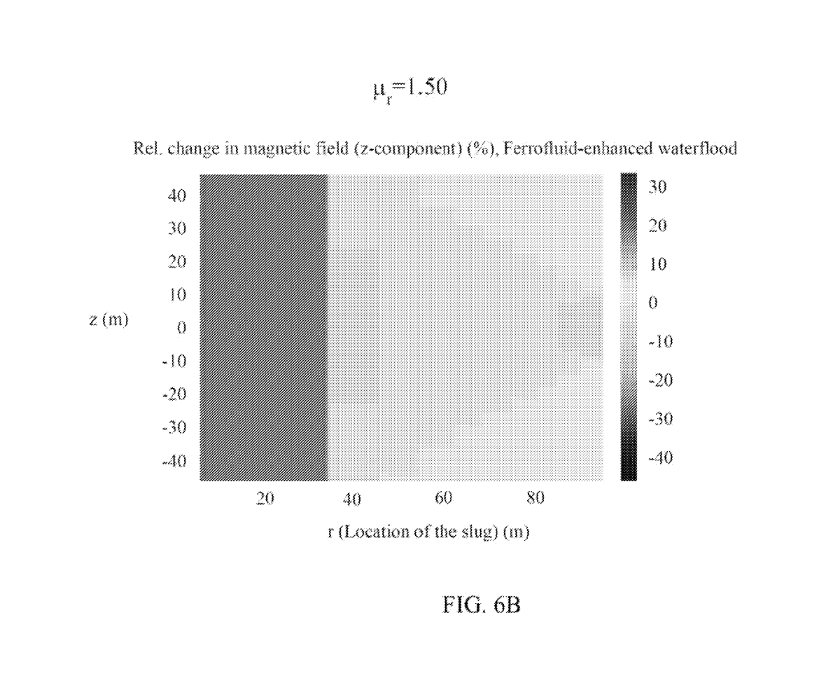

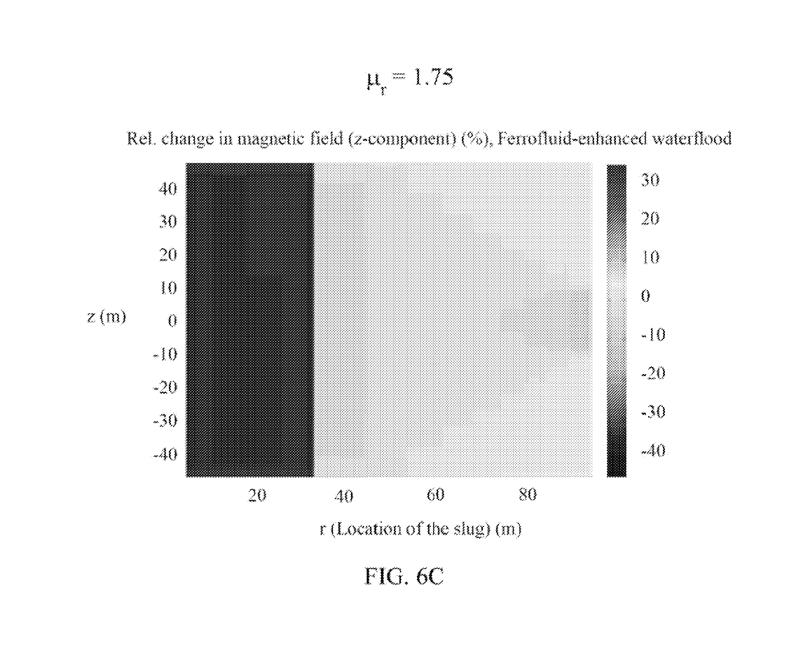

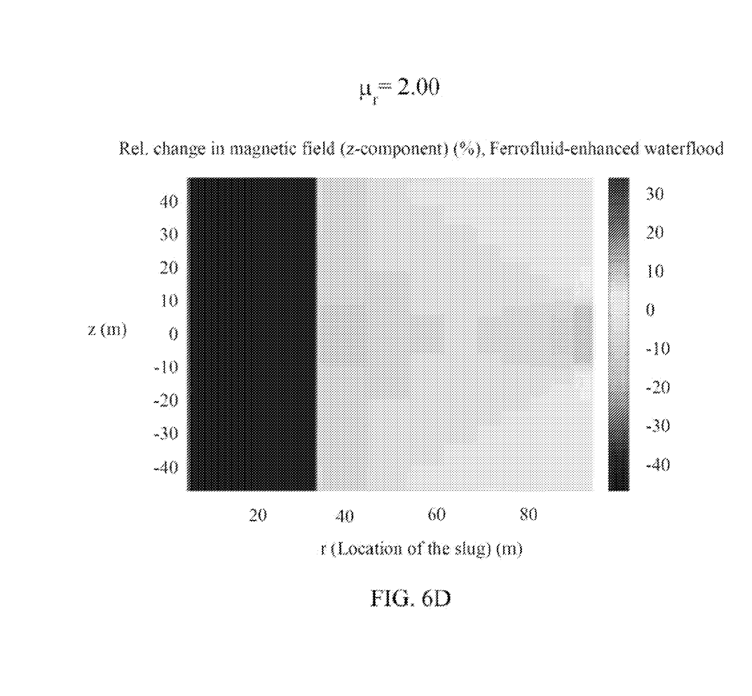

FIG. 6 shows similarly the same sensitivity analysis, but in 2D space to make comparisons easier. In FIG. 6, the z vertical axis corresponds to measurement locations along the observation well, and the horizontal axis identifies the location of the ferrofluid slug. Based on both FIGS. 5 and 6, maximum cross-well sensitivity is achieved when the ferrofluid slug is either close to the source (i.e., transmitter located at the injection point) or to the receivers. When the ferrofluid slug is propagating in the interwell region (i.e., in between the end points), the measurement sensitivity is suppressed. The observed effect is somewhat similar to the effect of a shadow when an object is located near a light source; when an object is located in front of a light source, it creates a shadow for observers looking directly at the light source. When the object is located close to the observer's eyes (signal receivers), one would not be able to spot the source clearly. The difference of the cross-well measurements here and the shadow effect is that the former creates brighter points (larger magnetic fields) off the line of sight.

The implication of this result is that one can realize the time the slug is dislodged from the injection point and can also predict in advance when the ferrofluid slug reaches the observatory point. However, there is an important difference in cross-well measurements obtained when the ferrofluid slug is close to the source and those obtained when the slug is close to the receivers. The latter exhibits a significant sensitivity to the boundaries of the reservoir layer carrying the ferrofluid slug, whereas the former shows minimal sensitivity to bed boundaries. Therefore, cross-well measurements obtained when the ferrofluid slug is approaching the observation point can potentially identify zones with large flow capacitance or permeability, i.e., “thief zones or regions of flow anisotropy.”

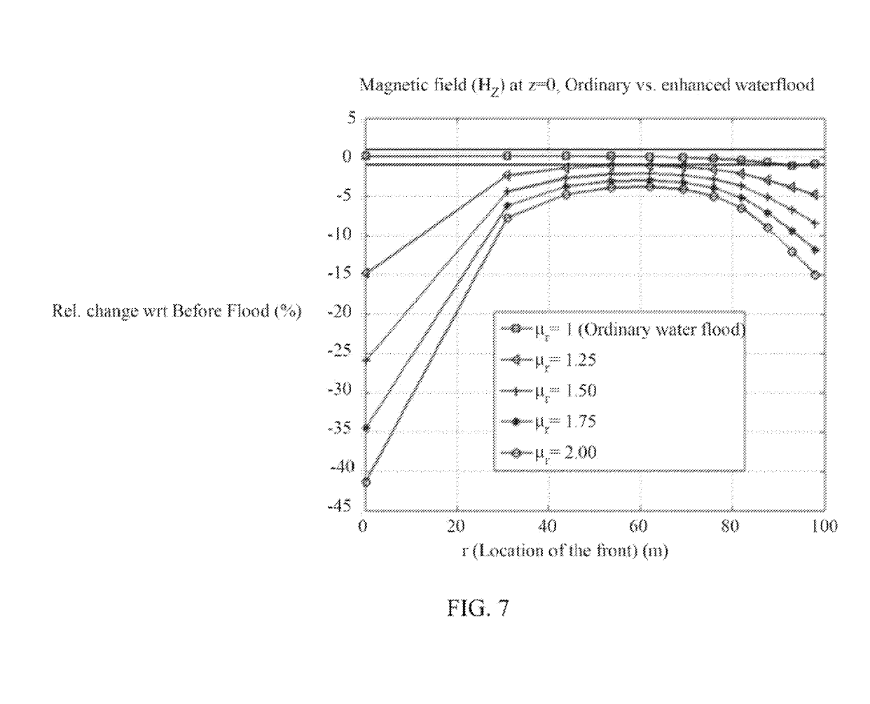

FIG. 7 illustrates the sensitivity of the measurements at z=0 at the observation well for four different values of magnetic permeability of the ferrofluid-flooded region. FIG. 7 indicates very clearly the enhanced cross-well sensitivity to the ferrofluid slug when the slug is near the source or approaching the receivers. The effect is intensified for larger magnetic permeabilities. FIG. 7 highlights the negligible sensitivity of the measurements to the conductivity alteration as a result of continuous brine injection in an ordinary waterflood.

Single-Well Measurements:

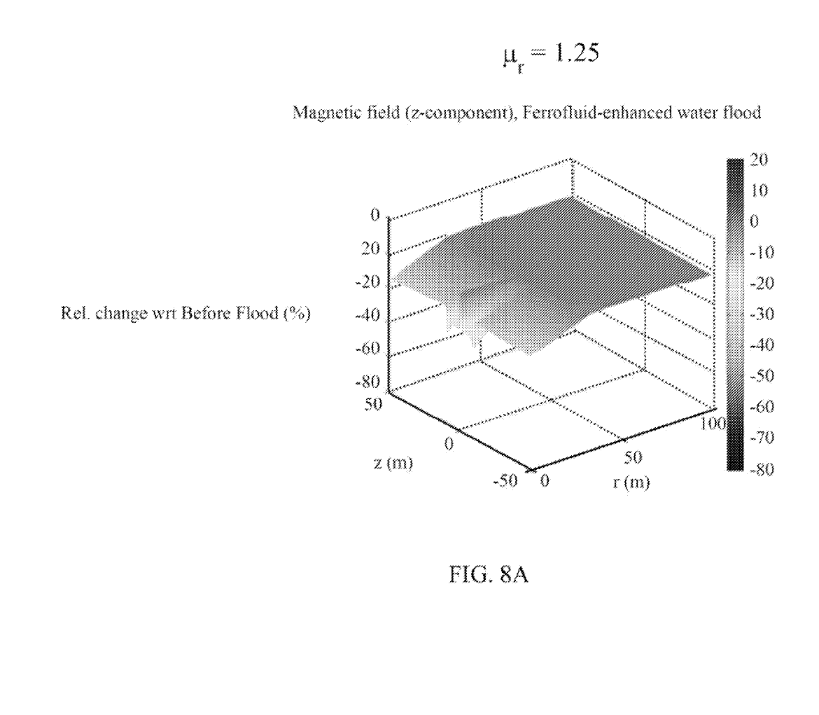

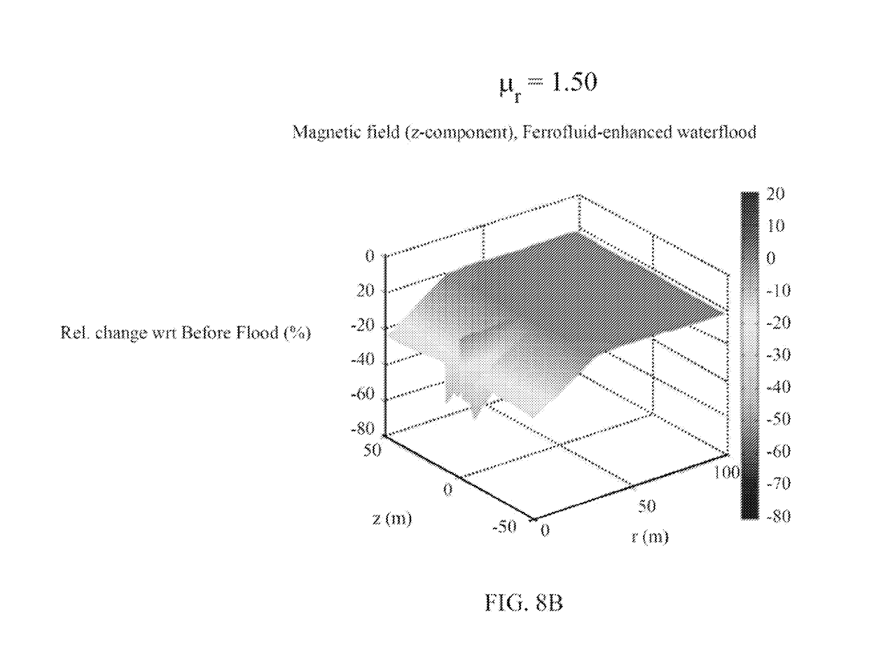

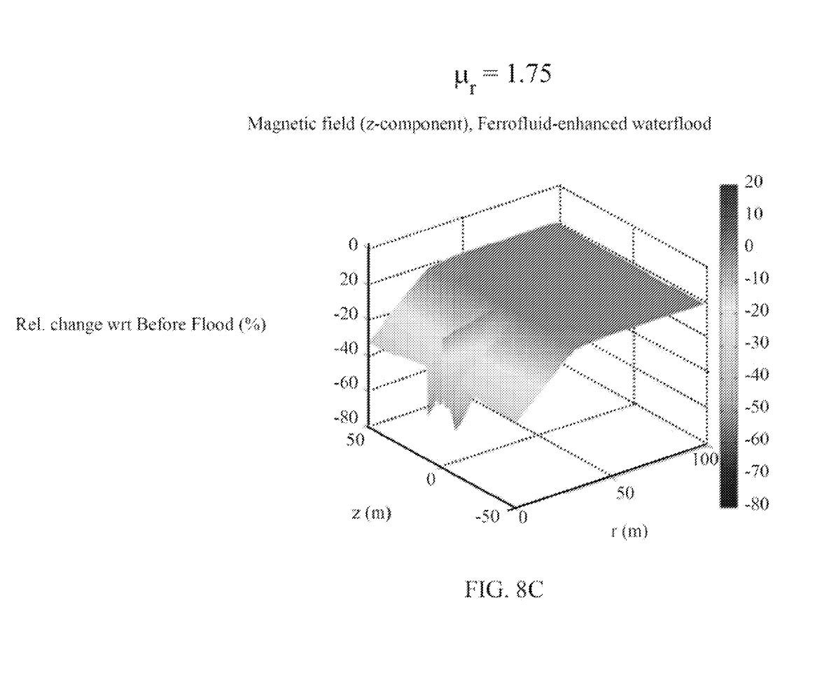

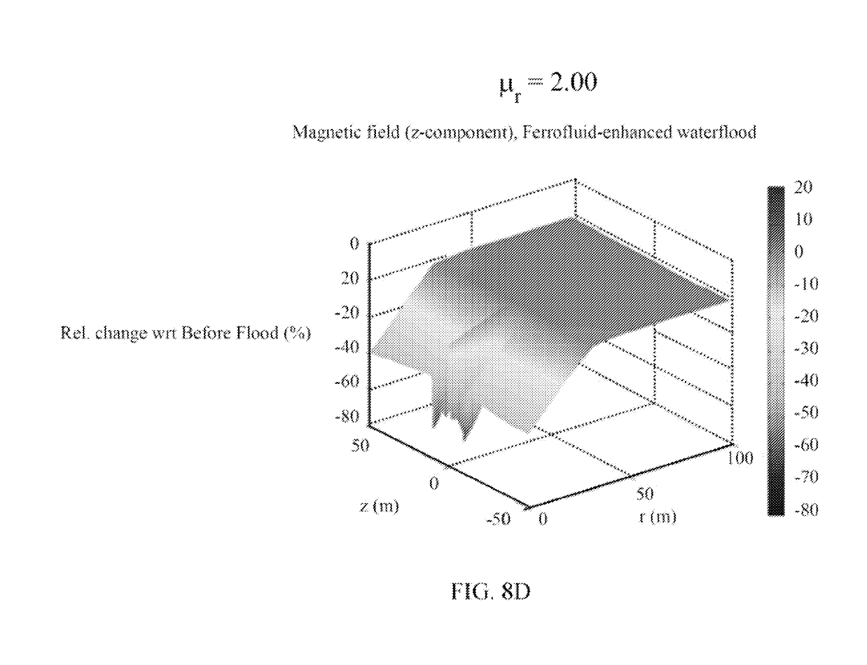

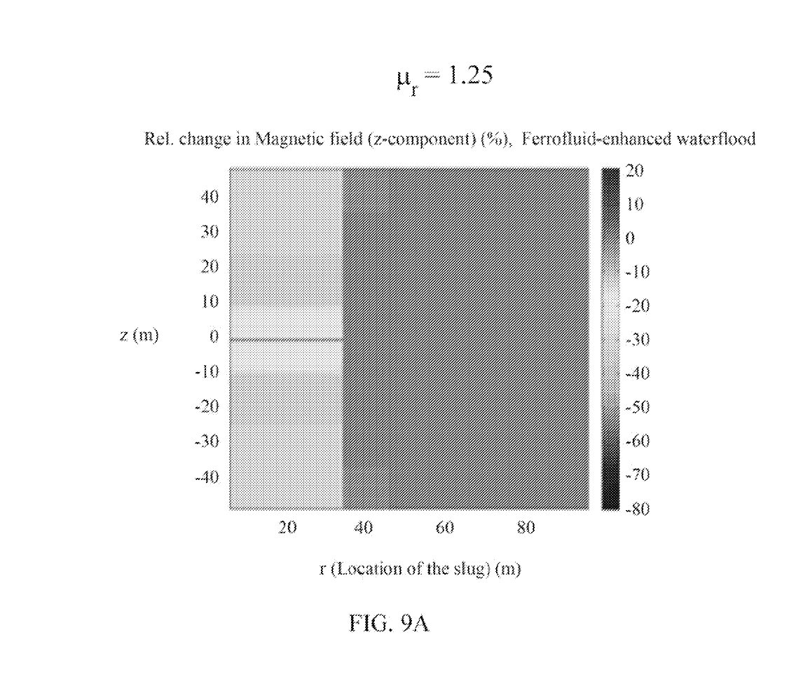

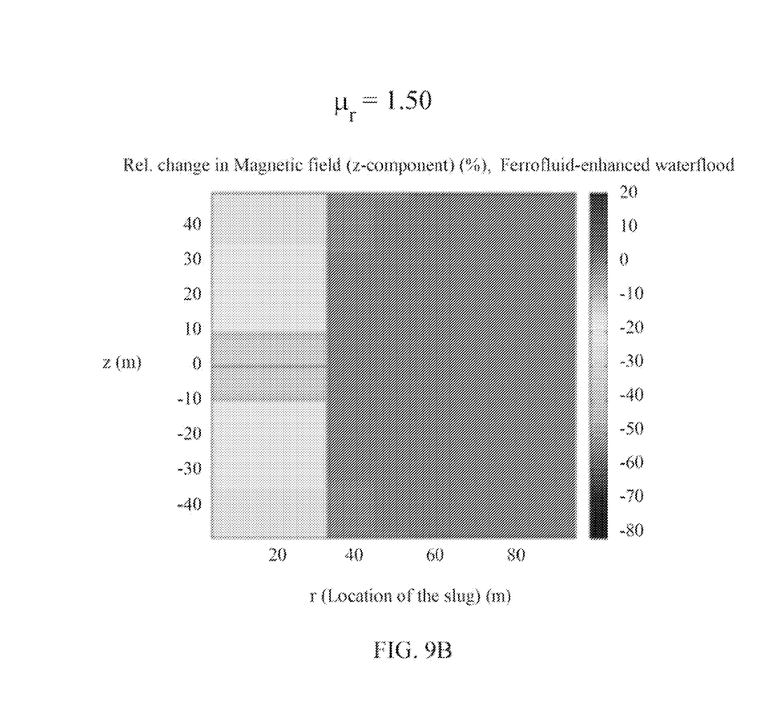

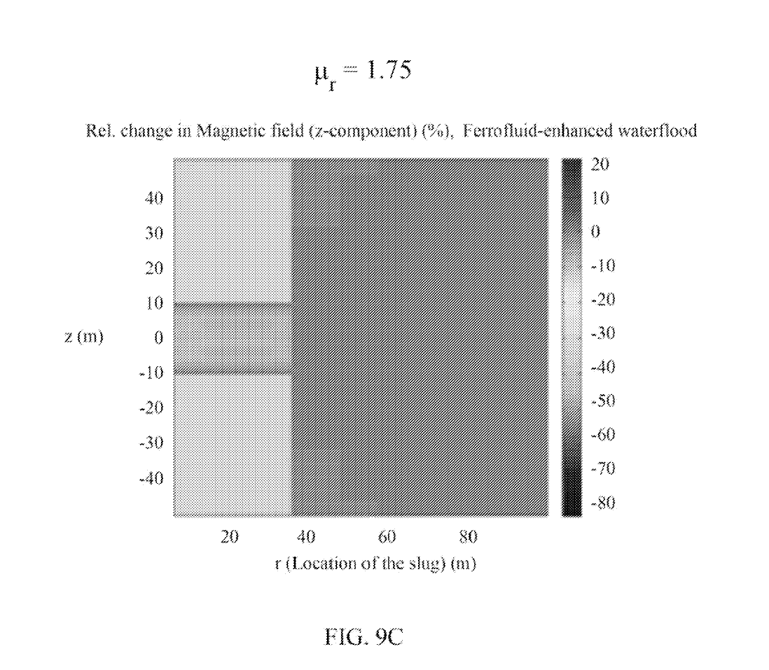

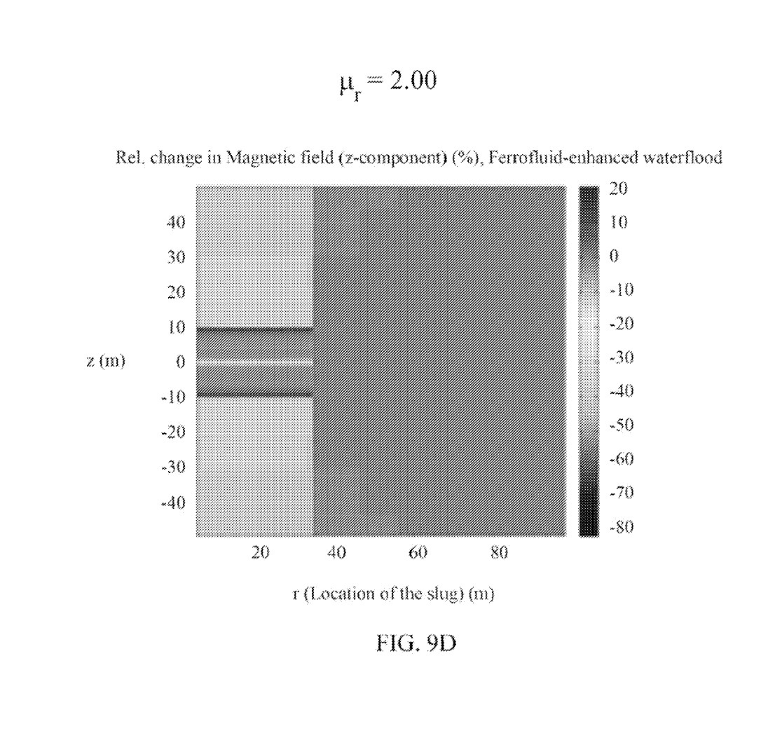

In this example, measurements are made with pad sensors assumed to be deployed at the injection borehole wall located at r=25 cm. FIG. 8 shows the z-component of the magnetic field (Hz) at the location of the injection well (receivers are deployed at r=25 cm) as a function of vertical distance along the wellbore. The z-component identifies the relative change of the signal with respect to the before-flood case, i.e., when there is no fluid injected into the formation. The x-axis corresponds to the vertical location along the injection well. The y-axis identifies the location of the propagating flood front. Any cross-section perpendicular to this axis corresponds to a well log at the injection well. FIG. 9 similarly shows the same sensitivity analysis, but in 2D space to make comparisons easier. In FIG. 9, the vertical z axis corresponds to measurement locations along the injection well, and the horizontal axis identifies the location of the ferrofluid slug.

Based on FIGS. 8 and 9, the single-well measurements are only sensitive to the ferrofluid slug when it is close to the transmitter. Beyond a certain distance away from the injection point, sensitivity is totally suppressed. However, single-well measurements acquired when the ferrofluid slug is close to the injection well exhibit high sensitivity to the boundaries of the reservoir layer carrying the ferrofluid slug (e.g., at z=±10).

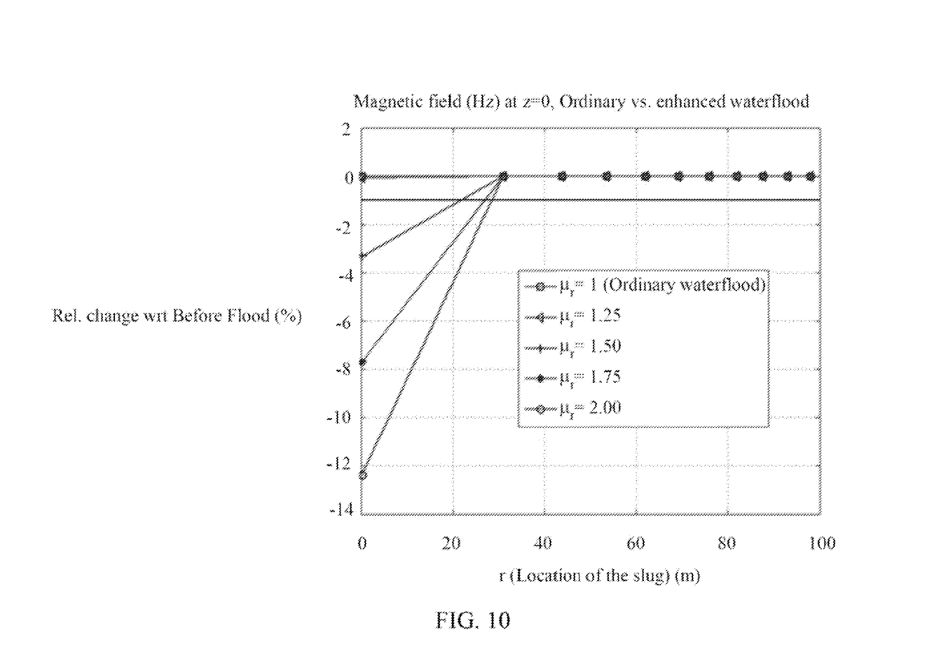

FIG. 10 illustrates the sensitivity of the measurements at z=0 at the injection well for four different values of magnetic permeability of the ferrofluid-flooded region. FIG. 10 very clearly indicates the single-well sensitivity to the ferrofluid slug when the slug is near the source (i.e., the injection point). The effect is intensified for larger magnetic permeabilities. FIG. 10 highlights the negligible sensitivity of the measurements to the conductivity alteration as a result of continuous brine injection in an ordinary waterflood.

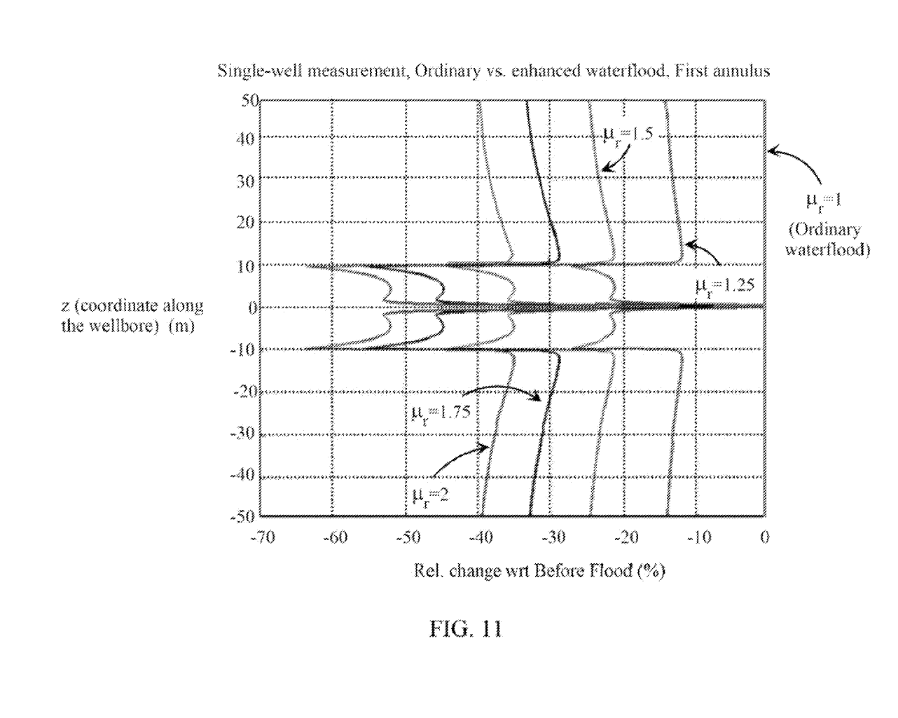

FIG. 11 shows the single-well measurements along the wellbore when the ferrofluid slug is at the first annulus, based on the FIG. 2 model, for four different values of magnetic permeability of the ferrofluid-flooded region. FIG. 11 emphasizes the negligible sensitivity to ordinary waterflood (e.g., brine injection). The measurements clearly identify the location of the reservoir layer boundaries (e.g., at z=±10).

Simulations indicate that cross-well measurements are quite sensitive to the location of the ferrofluid slug. The sensitivity is more pronounced when the ferrofluid slug is close to the transmitter or is approaching the observatory well compared to the case when the slug is somewhere in the interwell region. Measurements acquired when the slug is close to the receivers exhibit larger sensitivity to the bed boundaries compared to those taken when the slug is close to the injection point.

Single-well measurements are sensitive to the slug propagation only when the slug is close to the injection point. Otherwise, measurement sensitivity is dramatically suppressed once the slug is sufficiently far from the injection well. The measurements exhibit quite considerable sensitivity to bed boundaries.

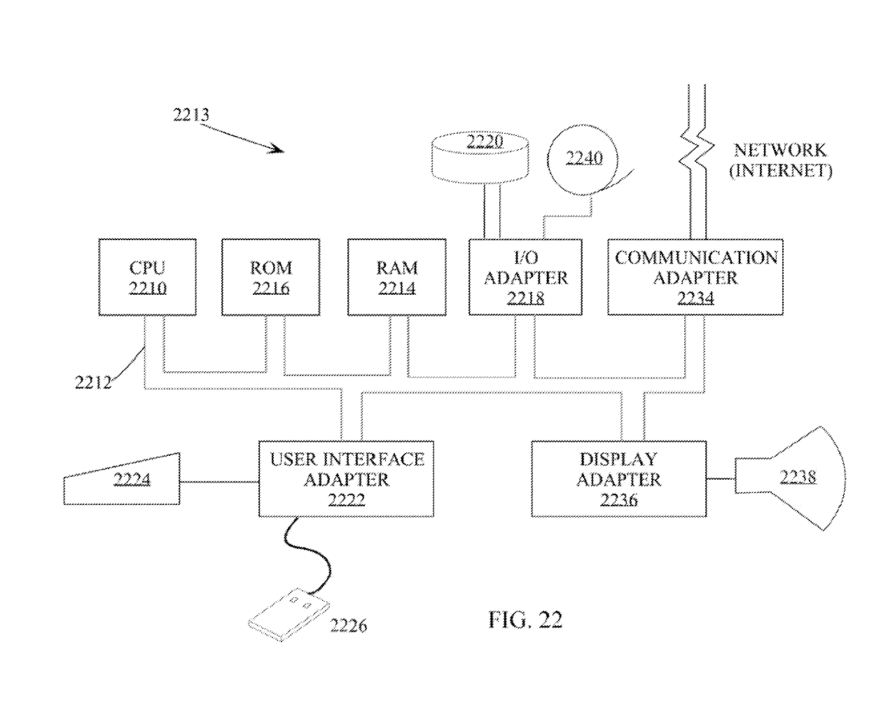

Embodiments of the present invention implement a multi-physics and multi-scale system and process (e.g., embodied in computer software, which may be implemented for operation utilizing a data processing system, such as illustrated in FIG. 22) to simulate imaging of hydrocarbon reservoirs using electromagnetic particles and electromagnetic tomography. Embodiments are applicable towards flood-front mapping and hydraulic fracture imaging. With respect to flood-front mapping, coated nanoparticles (or their software representation) may be injected. In case of fracture imaging, the contrast agents (or their software representation) may either be injected as proppants, fibers, or nanoparticles suspended in the solution (similar to flood-front mapping application).

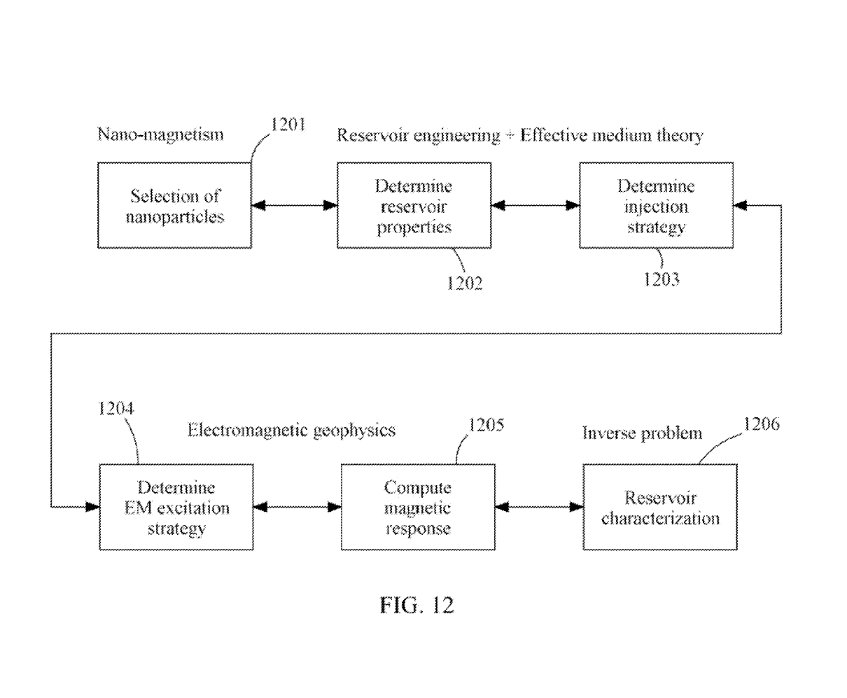

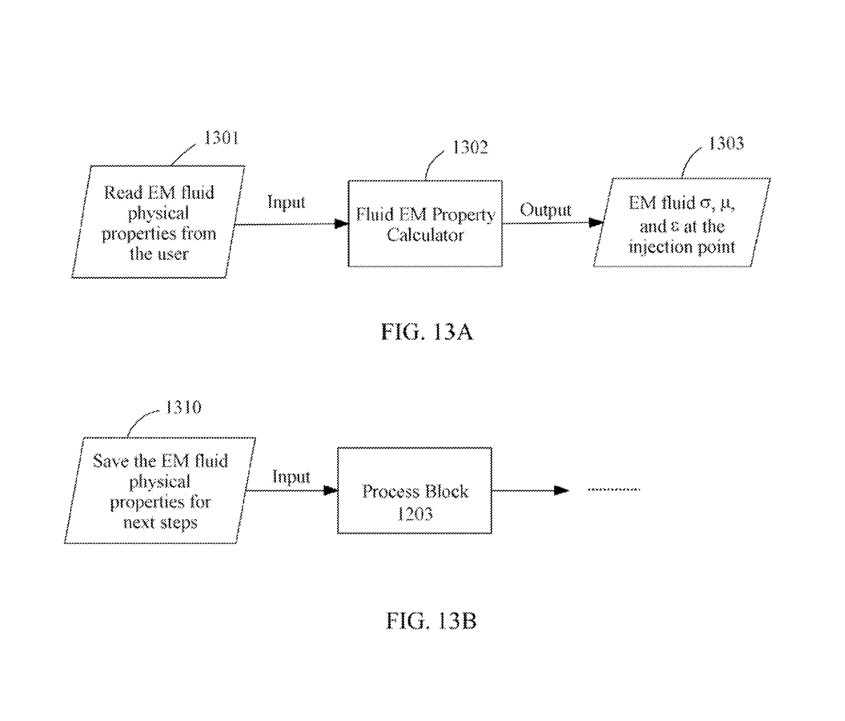

Embodiments of the present invention comprise several processing modules, as illustrated by the schematic block diagram in FIG. 12, all or some of which may be implemented in computer software. In processing module 1201, a contrast agent is selected. More specifically, referring to FIG. 13A, the EM properties of the EM fluid (with the selected contrast agent) are determined in steps 1301-1303. For example, the user may select the type of nanoparticles for the contrast agent and the pertinent physical properties in step 1301, which may include particle size and size distribution, particle volume concentration, particle shape, material (e.g., iron, iron oxide, etc.), carrier liquid (e.g., water, oil, emulsion, etc.), and the form of the contrast agent (for fracture imaging): proppant, proppant coating, fiber, coated nanoparticles. The EM fluid properties are then determined in step 1302 and output in step 1303 for use by other modules in FIG. 12 for effective properties determinations.

A software module could be utilized to determine the EM fluid properties, which may use Maxwell Garnett equations (e.g., see, A. H. Sihvola, Electromagnetic Mixing Formulas and Applications, London, U.K., Inst. Elect. Eng., 1999) and the Bruggeman equation also known as effective medium theory: EMT (A. H. Sihvola, Electromagnetic Mixing Formulas and Applications, London, U.K., Inst. Elect. Eng., 1999)

The most commonly used mixing rules are the Maxwell Garnett approximation (“MGA”)

$${μ}_{eff} = 1 + 3 f {μ}_{e} \frac{{μ}_{i} - {μ}_{e}}{{μ}_{i} + 2 {μ}_{e} - f ( {μ}_{i} - {μ}_{e} )} , \qquad ( 1 a )$$

and the Bruggeman effective medium theory (“EMT”)

$$( 1 - f ) \frac{{μ}_{e} - {μ}_{eff}}{{μ}_{e} + 2 {μ}_{eff}} + f \frac{{μ}_{i} - {μ}_{eff}}{{μ}_{i} + 2 {μ}_{eff}} = 0 , \qquad ( 1 b )$$

where μ_{eff} is the effective magnetic permeability of the composite (i.e., the rock formation saturated with the ferrofluid), μᵢ is the magnetic permeability of the inclusion, μₑ is the magnetic permeability of the matrix (e.g., the rock formation without the ferrofluid), and f is the volume fraction of the inclusions within the matrix (i.e., the volume fraction of the ferrofluid in the rock formation). Both Equations (1a) and (1b) are for spherical inclusions.

If the inclusions have shapes other than spherical, both MGA and EMT equations should be modified. In case of MGA, the modified equation for randomly oriented ellipsoidal inclusions is

$${μ}_{eff} = {μ}_{e} + {μ}_{e} \frac{\frac{f}{3} {\sum }_{j = x , y , z} \frac{{μ}_{i} - {μ}_{e}}{{μ}_{e} + {N}_{j} ( {μ}_{i} - {μ}_{e} )}}{1 - \frac{f}{3} {\sum }_{j = x , y , z} \frac{{N}_{j} ( {μ}_{i} - {μ}_{e} )}{{μ}_{e} + {N}_{j} ( {μ}_{i} - {μ}_{e} )}} , \qquad ( 2 a )$$

where Nⱼ's are the demagnetization factors of the ellispoid along x, y, and z directions, respectively:

$$\begin{matrix}{N}_{x} = \frac{{a}_{x} {a}_{y} {a}_{z}}{( {a}_{x}^{2} - {a}_{y}^{2} ) \sqrt{{a}_{x}^{2} - {a}_{z}^{2}}} [ F ( φ , k ) - E ( φ , k ) ] , & ( 2 b ) \\ {N}_{z} = \frac{{a}_{y}}{{a}_{y}^{2} - {a}_{z}^{2}} [ {a}_{y} - \frac{{a}_{x} {a}_{z}}{\sqrt{{a}_{x}^{2} - {a}_{z}^{2}}} E ( φ , k ) ] , & ( 2 c ) \\ {N}_{y} = 1 - {N}_{x} - {N}_{z} , & ( 2 d )\end{matrix}$$

with aₓ, a_{y}, and a_{z} the semi-axes of the ellipsoid in x, y, and z directions and the incomplete elliptic integrals defined as

$$\begin{matrix}F ( φ , k ) = {\int }_{0}^{φ} \frac{d θ}{\sqrt{1 - {k}^{2} {sin}^{2} θ}} , & ( 2 e ) \\ E ( φ , k ) = {\int }_{0}^{φ} \sqrt{1 - {k}^{2} {sin}^{2} d θ} . & ( 2 f )\end{matrix}$$

For prolate ellispoids (aₓ>a_{y}=a_{z})

$$\begin{matrix}{N}_{x} = \frac{1 - {e}^{2}}{2 {e}^{3}} ( ln \frac{1 + e}{1 - e} - 2 e ) , \\ and & ( 3 a ) \\ {N}_{y} = {N}_{z} = \frac{1}{2} ( 1 - {N}_{x} ) , & ( 3 b )\end{matrix}$$

where the eccentricity is e=\sqrt{1−a_{y}²/aₓ²}. For oblate ellipsoids (aₓ=a_{y}>a_{z})

$$\begin{matrix}{N}_{z} = \frac{1 + {e}^{2}}{{e}^{3}} ( e - {tan}^{- 1} e ) , & ( 4 a ) \\ {N}_{x} = {N}_{y} = \frac{1}{2} ( 1 - {N}_{z} ) , \\ where e = \sqrt{\frac{{a}_{x}^{2}}{{a}_{z}^{2}} - 1} . & ( 4 b )\end{matrix}$$

For instance, the case of randomly oriented needles gives

$${μ}_{eff} = {μ}_{e} + f ( {μ}_{i} - {μ}_{e} ) \frac{{μ}_{i} + 5 {μ}_{e}}{( 3 - 2 f ) {μ}_{i} + ( 3 + 2 f ) {μ}_{e}} , \qquad ( 5 )$$

and for randomly oriented discs, Equation (2.63) yields

$${μ}_{eff} = {μ}_{e} + f ( {μ}_{i} - {μ}_{e} ) \frac{ 2 {μ}_{i} + {μ}_{e}}{( 3 - f ) {μ}_{i} + f {μ}_{e}} . \qquad ( 6 )$$

The Bruggeman equation (EMT) for the case when the inclusions are randomly oriented ellipsoids is

$${μ}_{eff} = {μ}_{e} + \frac{f}{3} ( {μ}_{i} - {μ}_{e} ) {\sum }_{j = x , y , z} \frac{{μ}_{eff}}{{μ}_{eff} + {N}_{j} ( {μ}_{i} - {μ}_{eff} )} , \qquad ( 7 )$$

with Nⱼ's defined in Equations (2b) to (4b).

Also, referring to FIG. 13B, the physical properties of the injection EM fluid are saved in step 1310 for the fluid-flow (reservoir) simulations in processing module 1203.

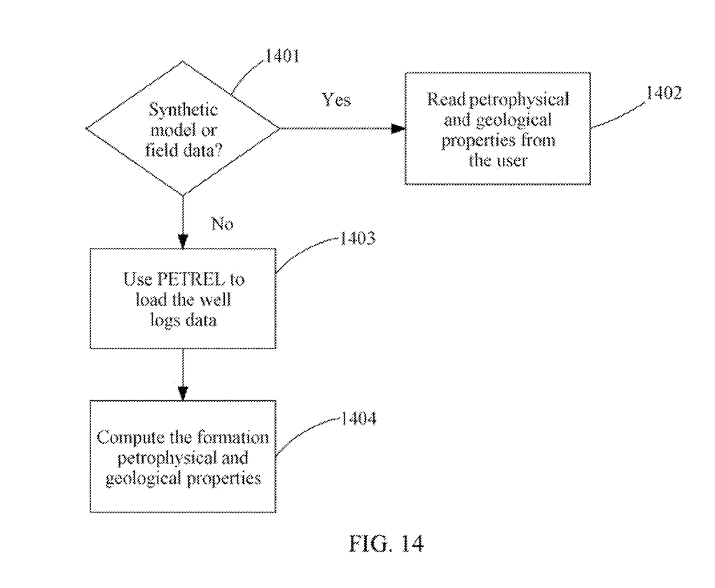

In processing module 1202, reservoir geological, petrophysical, and geomechanical properties are determined. After selecting the nanoparticle type and the corresponding ferrofluid, the user inputs the petrophysical properties of the subsurface formation under consideration. More specifically, referring to FIG. 14, the static petrophysical and geologic model of the formation is determined. With reference to step 1401, these parameters may be input either manually by the user (step 1402), or through using a synthetic model (e.g., a software program referred to as PETREL), based on the acquired well logs, if available. The parameters may include rock porosity, rock permeability, initial saturations of each phase, capillary pressure curve, relative permeability curves, salinity and pH, natural or induced fractures, mineralogy of the formation, shale/clay content, layering of the formation with the corresponding thicknesses, formation anisotropy, formation heterogeneity, and stress state of the formation (principal stress values and orientations). In step 1403, PETREL may be used to correlate the well logs obtained from the wells in the field to provide the formation petrophysical and geologic properties in step 1404.

Once the user and/or system selects properties of the reservoir (processing module 1202) and the particle injectates (processing module 1201), processing module 1203 takes these inputs and determines an injection strategy and its parameters. These parameters may include injection rate, injection pressure, injected concentration, injection duration, and injection stages. In an actual injection in a geological formation, contrast agents may be injected in combination with other materials, e.g., a polymer for decreasing dispersion or surfactants for reducing the interfacial tension. For example, in a case of fractures, a polymer, proppant, fiber, chemicals, etc. may accompany the contrast agent injection.

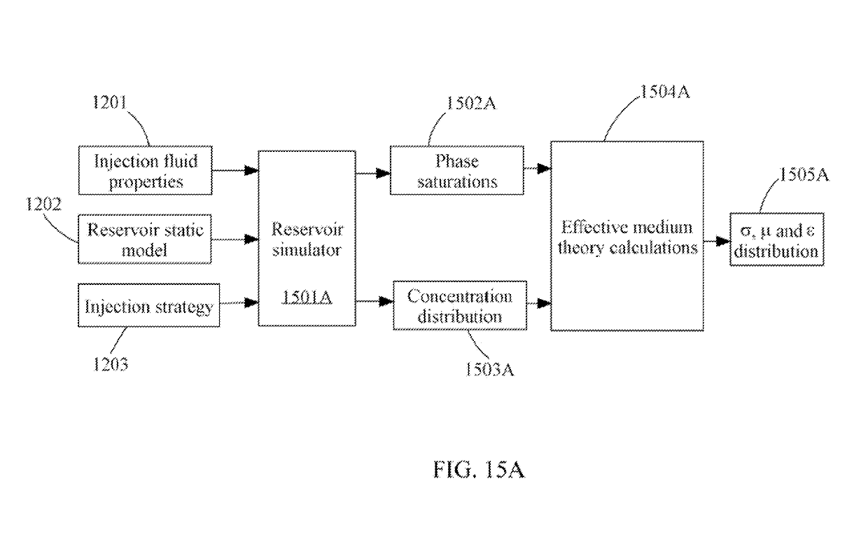

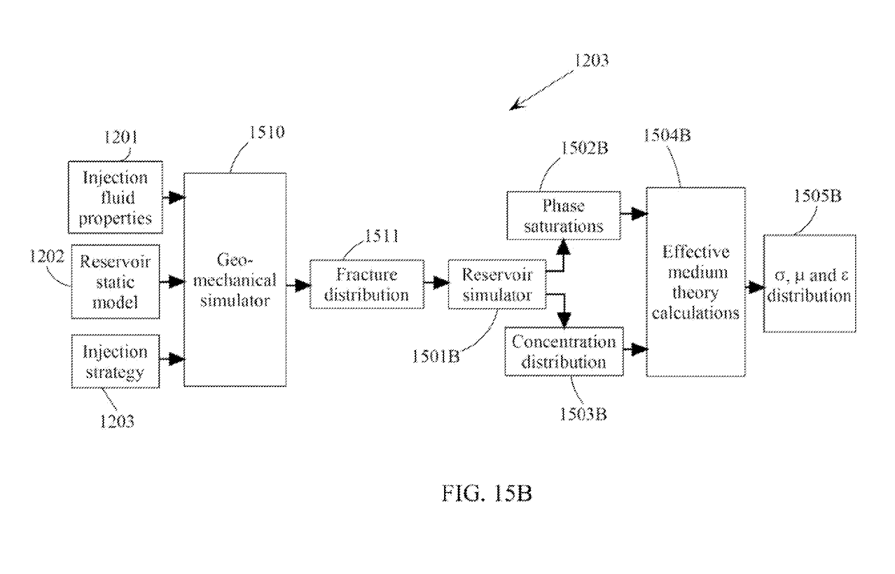

FIG. 15A illustrates a processing block diagram for a flood mapping application of processing module 1203. In embodiments of the present invention, the reservoir simulation 1501A may be implemented using a software program referred to as UT CHEM, which is publically available at http://www.cpge.utexas.edu/utchem/, which is hereby incorporated by reference herein. After performing the simulations up to this stage, the particle distribution is obtained. Based on the determined concentration distribution profile 1503A, the saturation of each phase 1502A, and the contrast agent solution properties identified in processing module 1501A, the processing module 1203 determines the modified electromagnetic properties 1505A of the rock formation using the effective medium theory 1504A. The fluid flow calculations in 1501A are performed using the data provided in steps 1, 2, and 3. Once the phase saturations 1502A and fluid concentrations 1503A are determined, the formation conductivity (σ), magnetic permeability (μ), and electric permittivity (∈) are determined using effective medium theory calculations 1504A.

For a hydraulic fracture imaging application of processing module 1203, the process illustrated in FIG. 15B may be implemented, wherein the fracture properties 1511 may be determined using a software program referred to as FracProPT or FRACADE, which handle geomechanics calculations 1510. Once the distribution of fractures 1511 is determined, they are imported into a reservoir simulator 1501B, which is capable of including fractures, e.g., Eclipse or CMG. Following fluid flow simulations, the concentration of the contrast agents 1503B is determined (which is either in the form of proppant, coating of the proppant, fiber, or particle dispersion). Once the distribution of the contrast agents is determined, the EM properties 1505B of the formation are calculated using effective medium theory calculations 1504B.

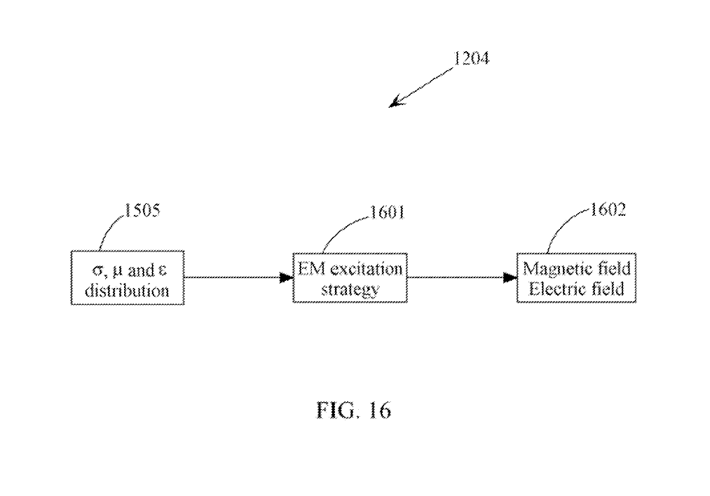

Referring to FIG. 16, the electromagnetic (“EM”) excitation strategy 1601 is determined for processing module 1204, including the magnetic response. This module determines the magnetic response based on the distribution of EM properties determined in the previous steps (e.g., a software module solves Maxwell's equations and determines the magnetic response based on the EM properties distribution determined in step 1505 and the excitation strategy determined in step 1601). Parameters for this stage may be excitation frequency, excitation source (e.g., magnetic dipole, electric dipole, point-source, or distributed source), source-receiver configuration (e.g., cross-well, single-well, surface to borehole, borehole to surface), and observation parameters (e.g., distance from the source, sensor deployment in production wells, horizontal wells, vertical wells, receiver arrays spacing). Once the excitation strategy 1601 is determined, the magnetic response 1602 may be determined using a numerical code (e.g., as implemented in a software program referred to as COMSOL, which is publically available at http://www.comsol.com/products/multiphysics/, which is hereby incorporated by reference herein). The candidates for magnetic response include magnetic field (different components: x, y, and z, amplitude and phase), electric field (different components: x, y, and z, amplitude and phase), voltage (amplitude and phase), and current (amplitude and phase).

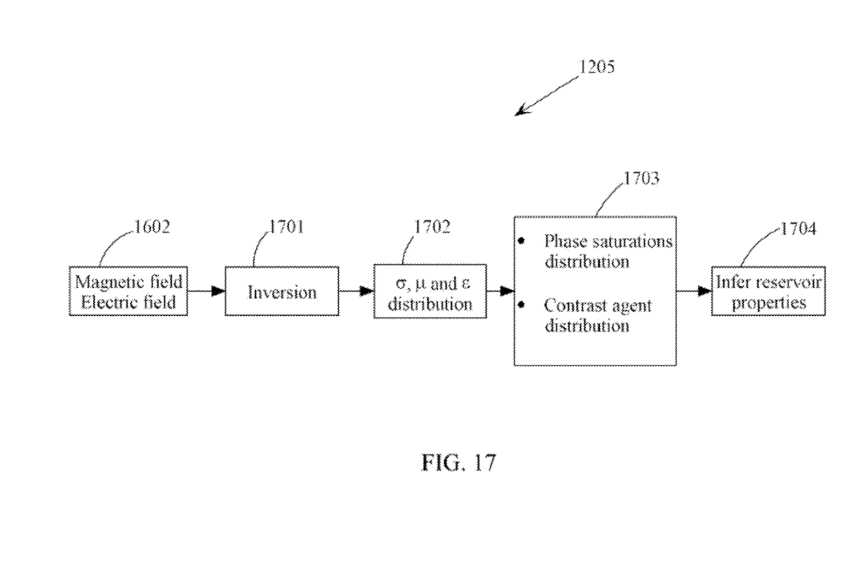

Reservoir characterization is further described with respect to FIG. 17. Forward model simulations may be used to characterize the reservoir. The effect of areal or vertical heterogeneity in permeability can be understood by investigating the forward data. Utilizing an inversion technique 1701, the injected magnetic material can then be imaged in the reservoir. Using the magnetic and/or electric field data 1602 as input, the inversion module 1701 determines the spatial distribution of sigma and mu 1702, which would result in the given data. An example of equations that may be used in a software module implementing such an inversion technique 1701 are equations 22-31 disclosed in J. Chen et al., Geophys, J. Int. (2002) 149, pp. 679-697, which is hereby incorporated by reference herein. Based on the spatial distribution of sigma and mu, the processing module 1205 determines the spatial distribution of the saturation of each phase and the concentration of the contrast agents 1703 that lead into to the obtained sigma and mu distribution. The saturation and concentration distributions allow for the reservoir structural properties to then be inferred 1704, such as the presence of a highly permeable layer, flow barriers, etc. The location of the injected material is a good indication of the reservoir capability to control the fluid flow. Moreover, the hydraulic and natural fractures can be assessed using the proposed integrated scheme.

Referring to FIG. 17, this module 1205 is dedicated to imaging the injected fluid, while previous stages are dedicated to forward modeling calculations. Forward modeling calculations help determine the sensitivity of the magnetic measurements to different parameters of the system. In this module 1205, however, the magnetic field data are assumed to be available either from field data or synthetic data. These data are used to obtain the contrast agent distribution 1703. The contrast agent distribution is an indirect means of measuring the porous media properties. For example, if the porosity and the permeability of a rock are large, the nanoparticles in that layer are more abundant and more concentrated. Likewise, if for example, the dispersivity of the medium is large, the nanoparticles are more dispersed.

An example of how a system would operate with the foregoing embodiments of the present invention is now provided. The following example is related to magnetic particles injection in a cross-well set-up for reservoir monitoring and hydraulic fracture evaluating. A similar concept applies for dielectric and conductive particles and also for configurations other than cross-well.

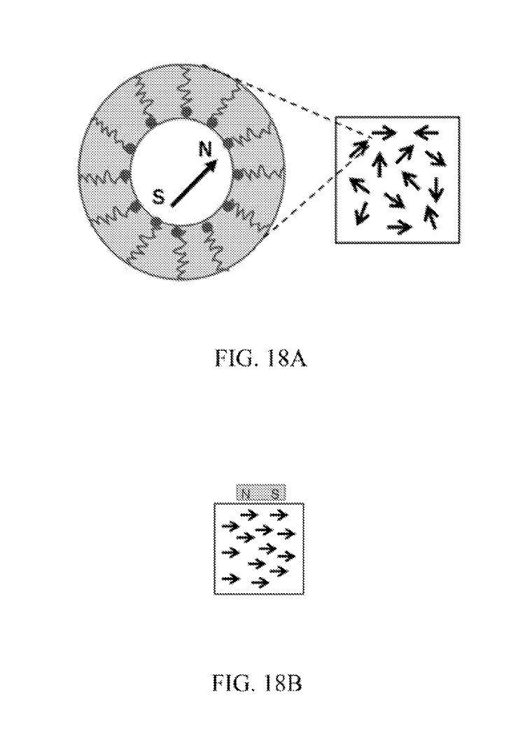

Starting from the nano-scale, the nanoparticles being so small, Brownian motion prevents them from aligning themselves within the carrier fluid (see FIG. 18(a)). Thus, the ferrofluid behaves as a paramagnetic material: when an external magnetic field is applied, the nanoparticles become oriented parallel to the field (see FIG. 18(b)), but they do not maintain magnetic moment after the field is removed, retaining no magnetic memory and reverting to random orientations.

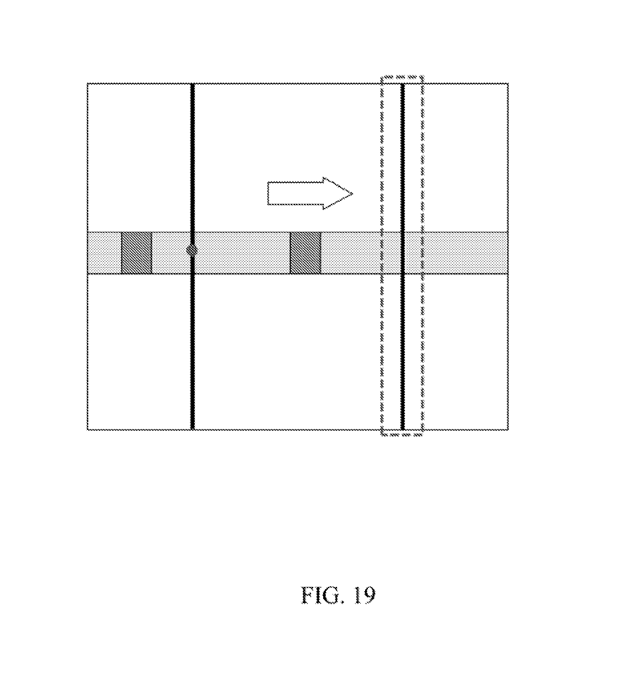

FIG. 19 illustrates an overall schematic showing the concept for application for a reservoir layer bedded between two low-permeability formations. The procedure may be summarized as follows: first, the ferrofluid is injected into the reservoir to deliver the superparamagnetic nanoparticles to the formation. Next, the reservoir is illuminated through an EM system; the source is deployed at the transmitting well and the receivers at the sensing well (setting up a cross-well system). The resulting EM signal is subsequently measured at the receivers, with particular attention to the perturbations caused by the presence of the nanoparticles to the EM measurements.

FIG. 20 illustrates a schematic of a cross-well EM data acquisition configuration. The transmitter (in the transmitter wellbore) traverses the logging interval while continuously propagating the primary electromagnetic field. The receiver (in the receiver wellbore) collects the primary and secondary (formation) fields.

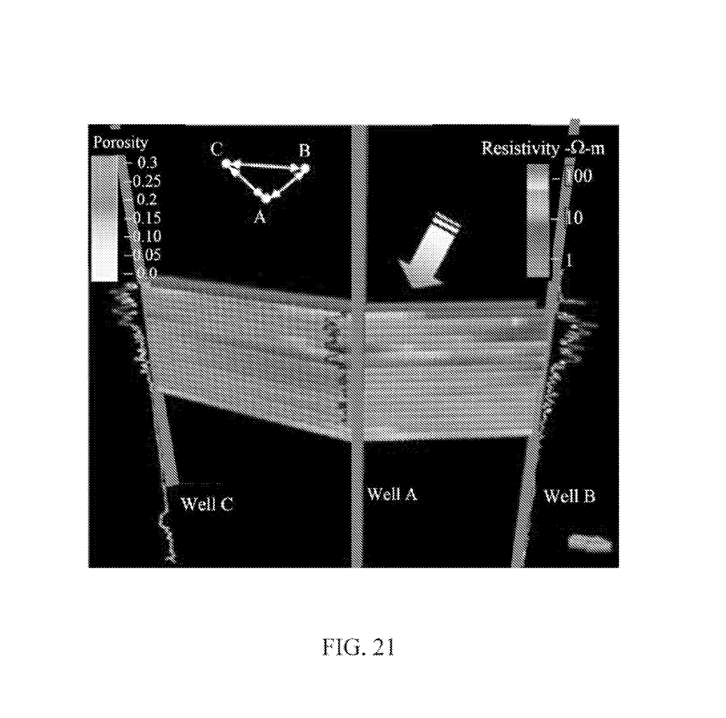

The outcome of such an EM illuminating system is a resistivity image obtained through inverse modeling. A sample of such a resistivity image is shown in FIG. 21. From the resistivity image, the fluid saturations can be determined and thus monitor the reservoir.

As will be appreciated by one skilled in the art, aspects of the present invention may be embodied as a system, method, and/or program product. Accordingly, aspects of the present invention may take the form of an entirely hardware embodiment, an entirely software embodiment (including firmware, resident software, micro-code, etc.), or embodiments combining software and hardware aspects that may all generally be referred to herein as a “circuit,” “module,” or “system.” Furthermore, aspects of the present invention may take the form of a program product embodied in one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing. More specific examples (a non-exhaustive list) of the computer readable storage medium may include the following: an electrical connection having one or more wires, a portable computer diskette, a hard disk, a random access memory (“RAM”), a read-only memory (“ROM”), an erasable programmable read-only memory (EPROM or Flash memory), an optical fiber, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, controller, or device. Program code embodied on a computer readable signal medium may be transmitted using any appropriate medium, including but not limited to wireless, wire line, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, controller, or device.

The flowcharts and block diagrams in the figures illustrate architecture, functionality, and operation of possible implementations of systems, methods and program products according to various embodiments of the present invention. In this regard, each block in the flowcharts or block diagrams may represent a module, segment, or portion of code, which comprises one or more executable program instructions for implementing the specified logical function(s). It should also be noted that, in some implementations, the functions noted in the blocks may occur out of the order noted in the figures. For example, two blocks shown in succession may, in fact, be executed substantially concurrently, or the blocks may sometimes be executed in the reverse order, depending upon the functionality involved.

Modules implemented in software for execution by various types of processors may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The data may provide electronic signals on a system or network.

These program instructions may be provided to a processor and/or controller of a general purpose computer, special purpose computer, or other programmable data processing apparatus (e.g., controller) to produce a machine, such that the instructions, which execute via the processor of the computer or other programmable data processing apparatus, create means for implementing the functions/acts specified in the flowchart and/or block diagram block or blocks.

It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. For example, a module may be implemented as a hardware circuit comprising custom VLSI circuits or gate arrays, off-the-shelf semiconductors such as logic chips, transistors, controllers, or other discrete components. A module may also be implemented in programmable hardware devices such as field programmable gate arrays, programmable array logic, programmable logic devices or the like.

Computer program code, i.e., instructions, for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These program instructions may also be stored in a computer readable storage medium that can direct a computer, other programmable data processing apparatus, controller, or other devices to function in a particular manner, such that the instructions stored in the computer readable medium produce an article of manufacture including instructions which implement the function/act specified in the flowchart and/or block diagram block or blocks.

The program instructions may also be loaded onto a computer, other programmable data processing apparatus, controller, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system may include any of various suitable security features, such as firewalls, access codes, encryption, de-encryption and the like. The database may be any type of database, such as relational, hierarchical, object-oriented, and/or the like. Common database products that may be used to implement the databases include DB2 by IBM, any of the database products available from Oracle Corporation, Microsoft Access by Microsoft Corporation, or any other database product. The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In these embodiments, the data corresponding to the key field in each of the merged data tables is preferably the same. However, data tables having similar, though not identical, data in the key fields may also be merged by using AGREP, for example.

Reference is made herein to “configuring” the retrofit control device. It should be understood that this may include selecting predefined logic blocks and logically associating them, such that they provide particular logic functions, which includes monitoring or control functions. It may also include programming computer software-based logic of retrofit control device, wiring discrete hardware components, or a combination of any or all of the foregoing.

Reference throughout this specification to “one embodiment,” “embodiments,” or similar language means that a particular feature, structure, or characteristic described in connection with the embodiments is included in at least one embodiment of the present invention. Thus, appearances of the phrases “in one embodiment,” “in an embodiment,” “embodiments,” and similar language throughout this specification may, but do not necessarily, all refer to the same embodiment. Furthermore, the described features, structures, aspects, and/or characteristics of the invention may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

In the descriptions herein, numerous specific details are provided, such as examples of programming, software modules, user selections, network transactions, database queries, database structures, hardware modules, hardware circuits, hardware chips, controllers, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations may be not shown or described in detail to avoid obscuring aspects of the invention.

With reference now to FIG. 22, a block diagram illustrating a computer system is depicted in which aspects of embodiments of the invention may be implemented. Computer system 2213 may employ a peripheral component interconnect (“PCI”) local bus architecture. Although the depicted example employs a PCI bus, other bus architectures such as Accelerated Graphics Port (“AGP”) and Industry Standard Architecture (“ISA”) may be used, among others. Processor (“CPU”) 2210, volatile memory (“RAM”) 2214, and non-volatile memory (“ROM”) 2216 may be connected to PCI local bus 2212 through a PCI Bridge (not shown). The PCI Bridge also may include an integrated memory controller and cache memory for processor 2210. Additional connections to PCI local bus 2212 may be made through direct component interconnection or through add-in boards. In the depicted example, a network communications adapter 2234, small computer system interface (“SCSI”) host bus adapter (not shown), and expansion bus interface (not shown) may be connected to PCI local bus 2212 by direct component connection. In contrast, audio adapter (not shown), graphics adapter (not shown), and audio display adapter (not shown) may be connected to PCI local bus 2212 by add-in boards inserted into expansion slots. A display device 2238 may be connected to the PCI local bus by the display adapter 2236.

A user interface adapter 2222 provides a connection for a keyboard 2224 and mouse 2226, modem (not shown), and additional memory (not shown). I/O adapter 2218 provides a connection for a hard disk drive 2220, tape drive 2240, and CD-ROM drive (not shown). Typical PCI local bus implementations will support three or four PCI expansion slots or add-in connectors.

An operating system may be run on processor 715 and used to coordinate and provide control of various components within computer system 2213. The operating system may be a commercially available operating system. An object oriented programming system such as Java may run in conjunction with the operating system and provide calls to the operating system from Java programs or programs executing on system 2213. Instructions for the operating system, the object-oriented operating system, and programs may be located on non-volatile memory 2216, and/or storage devices, such as a hard disk drive 2220, and may be loaded into volatile memory 2214 for execution by processor 2210.

Those of ordinary skill in the art will appreciate that the hardware in FIG. 22 may vary depending on the implementation. Other internal hardware or peripheral devices, such as flash ROM (or equivalent nonvolatile memory) or optical disk drives and the like, may be used in addition to or in place of the hardware depicted in FIG. 22. Also, the processes of the present invention may be applied to a multiprocessor computer system.

As another example, computer system 2213 may be a stand-alone system configured to be bootable without relying on some type of network communication interface, whether or not computer system 2213 includes some type of network communication interface. As a further example, computer system 2213 may be an embedded controller, which is configured with ROM and/or flash ROM providing non-volatile memory storing operating system files or user-generated data.

The depicted example in FIG. 22 and above-described examples are not meant to imply architectural limitations. Further, a computer program form of the present invention may reside on any computer readable storage medium (i.e., floppy disk, compact disk, hard disk, tape, ROM, RAM, etc.) used by a computer system. (The terms “computer,” “system,” and “computer system” may be used interchangeably herein.)

Benefits, advantages and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims.

Those skilled in the art having read this disclosure will recognize that changes and modifications may be made to the embodiments without departing from the scope of the present invention. It should be appreciated that the particular implementations shown and described herein may be illustrative of the invention and its best mode and may be not intended to otherwise limit the scope of the present invention in any way. Other variations may be within the scope of the following claims.

While this specification contains many specifics, these should not be construed as limitations on the scope of the invention or of what can be claimed, but rather as descriptions of features specific to particular implementations of the invention. Headings herein may be not intended to limit the invention, embodiments of the invention or other matter disclosed under the headings.

As used herein, the terms “comprises,” “comprising,” or any other variation thereof, may be intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

Herein, the term “or” may be intended to be inclusive, wherein “A or B” includes A or B and also includes both A and B.

The terminology used herein is for the purpose of describing particular embodiments only and is not intended to be limiting of the invention. As used herein, the singular forms “a,” “an,” and “the” may be intended to include the plural forms as well, unless the context clearly indicates otherwise. It will be further understood that the terms “comprises” and/or “comprising,” when used in this specification, which may include the claims herein below, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below may be intended to include any structure, material, or act for performing the function in combination with other claimed elements as specifically claimed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as may be suited to the particular use contemplated.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

Any steps recited in any method or process claims may be executed in any order and are not limited to the order presented in the claims. Means-plus-function or step-plus function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

All publications and patent applications are herein incorporated by reference to the same extent as if each individual publication or patent application was specifically and individually indicated to be incorporated by reference.

1. A system for modeling characteristics of a geological formation, comprising:
a first processing module configured to select a contrast agent to inject into the geological formation;
a second processing module configured to receive physical properties of the geological formation;
a third processing module configured to determine a strategy for injecting the contrast agent into the geological formation, wherein the injection strategy is determined as a function of the selected contrast agent and the received physical properties of the geological formation;
a fourth processing module configured to determine parameters for electromagnetic excitation of the geological formation; and
a fifth processing module configured to determine a magnetic response of the contrast agent injected into the geological formation as a function of the electromagnetic excitation parameters.

2. The system as recited in claim 1, further comprising a processing module configured to determine a characterization of the geological formation as a function of the magnetic response.

3. The system as recited in claim 1, wherein the first processing module comprises determining electromagnetic properties of a fluid containing the contrast agent, wherein the fluid is injected into the geological formation.

4. The system as recited in claim 1, wherein the physical properties of the geological formation comprise geological, petrophysical, and geomechanical properties.

5. The system as recited in claim 4, wherein the physical properties of the geological formation may be determined by a synthetic modeling software program utilizing well log statistics from an actual geological formation.

6. The system as recited in claim 1, wherein the injection strategy comprises parameters selected from the group consisting of injection rate, injection pressure, injected concentration, and injection duration.

7. The system as recited in claim 1, wherein the electromagnetic excitation parameters are selected from the group consisting of excitation frequency, excitation source, source-receiver configuration, and observation parameters.

8. The system as recited in claim 3, wherein the injection strategy comprises:
a reservoir simulator configured to produce phase saturations and a concentration distribution of the injected fluid into the geological formation with its received physical properties; and
an effective medium theory processing module configured to produce conductivity, magnetic permeability, and electric permittivity parameters of the geological formation as a function of the phase saturations and the concentration distribution of the injected fluid into the geological formation.

9. The system as recited in claim 3, wherein the injection strategy comprises:
a geomechanical simulator configured to produce a distribution of fractures in the geological formation for a modeled hydraulic fracturing simulation;
a reservoir simulator configured to produce phase saturations and a concentration distribution of the injected fluid into the geological formation as a function of the distribution of fractures in the geological formation; and
an effective medium theory processing module configured to produce conductivity, magnetic permeability, and electric permittivity parameters of the geological formation as a function of the phase saturations and the concentration distribution of the injected fluid into the geological formation.

10. A method for evaluating characteristics of a geological formation, comprising:
selecting properties of a contrast agent;
determining electromagnetic properties of a fluid containing the contrast agent, wherein the fluid is injected into the geological formation
inputting physical properties of the geological formation;
determining a strategy for injecting the contrast agent into the geological formation, wherein the injection strategy is determined as a function of the properties of the contrast agent and the physical properties of the geological formation;
determining parameters for electromagnetic excitation of the geological formation; and
determining a magnetic response of the contrast agent injected into the geological formation as a function of the electromagnetic excitation parameters.

11. The method as recited in claim 10, further comprising determining a characterization of the geological formation as a function of the magnetic response.

12. The method as recited in claim 10, wherein the physical properties of the geological formation comprise geological, petrophysical, and geomechanical properties.

13. The method as recited in claim 12, wherein the physical properties of the geological formation may be determined by a synthetic modeling software program utilizing well log statistics from an actual geological formation.

14. The method as recited in claim 10, wherein the injection strategy comprises parameters selected from the group consisting of injection rate, injection pressure, injected concentration, and injection duration.

15. The method as recited in claim 10, wherein the electromagnetic excitation parameters are selected from the group consisting of excitation frequency, excitation source, source-receiver configuration, and observation parameters.

16. The method as recited in claim 10, wherein determining the injection strategy comprises:
producing phase saturations and a concentration distribution of the injected fluid into the geological formation with its received physical properties; and
producing conductivity, magnetic permeability, and electric permittivity parameters of the geological formation as a function of the phase saturations and the concentration distribution of the injected fluid into the geological formation.

17. The method as recited in claim 16, wherein the producing of the phase saturations and the concentration distribution of the injected fluid into the geological formation with its received physical properties is performed with a reservoir simulator software program.

18. The method as recited in claim 16, wherein the producing of the conductivity, magnetic permeability, and electric permittivity parameters of the geological formation as a function of the phase saturations and the concentration distribution of the injected fluid into the geological formation is performed utilizing a software program implementing effective medium theory algorithms.

19. The method as recited in claim 10, wherein determining the injection strategy comprises:
producing a distribution of fractures in the geological formation for a modeled hydraulic fracturing simulation;
producing phase saturations and a concentration distribution of the injected fluid into the geological formation as a function of the distribution of fractures in the geological formation; and
producing conductivity, magnetic permeability, and electric permittivity parameters of the geological formation as a function of the phase saturations and the concentration distribution of the injected fluid into the geological formation.

20. The method as recited in claim 19, wherein the producing of the distribution of fractures in the geological formation for the modeled hydraulic fracturing simulation is performed with a geomechanical simulator software program.

21-29. (canceled)
